(19) United States
(12) Patent Application Publication
(10) Pub. No.: US 2022/0165013 A1
(43) Pub. Date: May 26, 2022

(54) Artificial Reality Communications

(71) Applicant: Facebook Technologies, LLC, Menlo Park, CA (US)

(72) Inventors: Jenna VELEZ, Seattle, WA (US); Gerrit Hendrik HOFMEESTER, Seattle, WA (US); Gagneet Singh MAC, Pacifica, CA (US); Cody CHAR, Seattle, WA (US); Jenny KAM, Seattle, WA (US); Yeliz KARADAYI, Seattle, WA (US); Camila Cortes DE ALMEIDA E DE VINCENZO, Seattle, WA (US); Paul Armistead HOOVER, Bothell, WA (US); Christopher ANDERSON, New York, NY (US); Pei Hsiu LUU, Oakland, CA (US); Trevor LUNDEEN, San Francisco, CA (US); Matt HARRISON, Pacifica, CA (US); Jing MA, Mill Creek, WA (US); Annika RODRIGUES, Lynnwood, WA (US)

(21) Appl. No.: 17/666,038

(22) Filed: Feb. 7, 2022

Related U.S. Application Data
(60) Provisional application No. 63/241,629, filed on Sep. 8, 2021.
(60) Provisional application No. 63/235,952, filed on Aug. 23, 2021.
(60) Provisional application No. 63/221,098, filed on Jul. 13, 2021.
(60) Provisional application No. 63/220,095, filed on Jul. 9, 2021.
(60) Provisional application No. 63/220,116, filed on Jul. 9, 2021.
(60) Provisional application No. 63/212,163, filed on Jun. 18, 2021.

(51) Int. Cl. G06T 13/40; H04L 51/18; G06T 19/00

(52) U.S. Cl. CPC G06T 13/40; G06T 2219/024; G06T 19/006; H04L 51/18

(57) ABSTRACT

Aspects of the present disclosure are directed to an avatar reaction system in which messaging can be initiated via an avatar. Aspects are also directed to automated controls for connecting an artificial reality trigger to an action. Aspects are further directed to adding a like to a gesture target based on interpreting a gesture. Aspects are yet further directed to administering a conversation thread, for a game, over a messaging platform. Additional aspects are directed to connecting a game with a conversation thread to coordinate game challenges. Further aspects are directed to establishing a shared space for a 3D call with participants' hologram representations mirrored as compared to how images of the participants are captured. Yet further aspects of the present disclosure are directed to scanning a physical space to onboard it as a messaging inbox and providing the scanned space for delivery point selection to a message sender.

### CROSS REFERENCE TO RELATED APPLICATIONS

This application claims priority to U.S. Provisional Application Nos. 63/212,163 filed Jun. 18, 2021, entitled “Artificial Reality Avatar Messaging Reactions,” 63/220,095 filed Jul. 9, 2021, entitled “Turn-Based Message Thread Games,” 63/220,116 filed Jul. 9, 2021, entitled “Message Thread Score Challenge Games,” 63/221,098 filed Jul. 13, 2021, entitled “Gesture to Like in Messaging Thread,” 63/235,952 filed Aug. 23, 2021’ entitled “Spatial Messaging with Scanned 3D Spaces , and 63/241,629 filed Sep. 8, 2021, entitled “Mirrored Spaces for 3D Calling.” Each patent application listed above is incorporated herein by reference in their entireties.

### BACKGROUND

Artificial reality (XR) devices such as head-mounted displays (e.g., smart glasses, VR/AR headsets), mobile devices (e.g., smartphones, tablets), projection systems, “cave” systems, or other computing systems can present an artificial reality environment where users can interact with “virtual objects” (i.e., computer-generated object representations appearing in an artificial reality environment). These artificial virtual reality systems can track user movements and translate them into interactions with the virtual objects. For example, an artificial reality system can track a user's hands, e.g., translating a grab gesture as picking up a virtual object. In various cases, a user can select, move, scale/resize, skew, rotate, change colors/textures/skins of, or apply any other imaginable action to a virtual object. In some cases, users can also augment real-world objects, which exist independently of the computer system controlling the artificial reality environment. For example, a user can select a real object and add a virtual overlay to change the way the object appears in the environment (e.g., color, texture), select a real object and be shown a virtual user interface next to the object to interact with it, or cause other interactions with virtual objects. In some existing systems, users can actively control avatars to navigate characters of themselves in an artificial reality environment.

Artificial reality systems provide an artificial reality environment, allowing users the ability to experience different worlds, learn in new ways, and make better connections with others. Devices such as head-mounted displays (e.g., smart glasses, VR/AR headsets), projection “cave” systems, or other computing systems can present an artificial reality environment to the user, who can interact with virtual objects in the environment using body gestures and/or controllers. These XR reality systems can track user movements and translate them into interactions with “virtual objects” (i.e., computer-generated object representations appearing in a virtual environment.) For example, an artificial reality system can track a user's hands, translating a grab gesture as picking up a virtual object. While a user is seeing and interacting with virtual objects, the user's physical movements occur in the real world. Some of the objects that a user can also interact with are real (real-world) objects, which exist independently of the computer system controlling the artificial reality environment.

Artificial reality devices provide new capabilities and interaction modes previously relegated to science fiction. Not only do these new devices allow users to create and interact with virtual objects, they also provide new ways of understanding user actions and intentions. Some such systems provide hardware to identify hand gestures. One such hand gesture recognition system relies on cameras that capture images of the user's hands to model the poses and motion of the user's hands. Typically in such systems, machine learning models are trained to take images of a user's hand(s) and either provide parameters for a kinematic model of the user's hands to defile a depicted pose or directly corelate depicted hand positions to one of a set of pre-defined poses. Other such systems use wearable devices such as gloves, rings, wrist bands, etc. that include various sensors (e.g., time-of-flight sensors, electromagnetic magnetic sensors, inertial motion units, pressure sensors, mechanical sensors, etc.) to identify hand poses. These systems also often employ trained machine learning models to interpret the output from these sensors in terms of a kinematic model or defined hand poses.

Originally, games were all about the interaction between players. People would get together for a bridge tournament or boardgame night and, as the game was played, players would share stories, make jokes, and occasionally take actions in the game. Since the advent of computerized games, many games have included a means for players to interact. Early computerized games provided textual messaging that a player could use to type messages to one or more other participants. Later, as technology evolved and bandwidth became more available, games incorporated voice communications between players. For example, players may be able to select another player to whom they could send a voice recording or could broadcast her voice to her team, providing real-time instructions and coordination between team members. This brought a more personal connection to many gaming experiences. However, in all these cases of computerized gaming, the communication between players has remained a secondary feature. In fact, players often find such communication features cumbersome or unhelpful, and end up disabling or ignoring them.

Video conferencing has become a major way people connect. From work calls to virtual happy hours, webinars to online theater, people feel more connected when they can see other participants, bringing them closer to an in-person experience. However, video calls remain a pale imitation of face-to-face interactions. Understanding body language and context can be difficult with only a two-dimensional (“2D”) representation of a sender. Further, interpersonal interactions with video are severely limited as communication often relies on relational movements between participants.

Some artificial reality systems may provide the ability for participants to engage in 3D calls, where a call participant can see a 3D representation (a “hologram”) of one or more other call participants. In such 3D calls, participants can experience interactions that more closely mimic face-to-face interactions. For example, an artificial reality device can include a camera array that captures images of a sending call participant, reconstructs a hologram (3D model) representation of the sending call participant, encodes the hologram for delivery to an artificial reality device of a recipient call participant, which decodes and displays the hologram as a 3D model in the artificial reality environment of the recipient call participant.

In an artificial reality environment, some of the objects that a user can see and interact with are virtual objects, which can be representations of objects generated by a computer system. Devices such as head-mounted displays (e.g., smart glasses, VR/AR headsets), mobile devices (e.g., smartphones, tablets), projection systems, “cave” systems, or other computing systems can present an artificial reality environment to the user, who can interact with virtual objects in the environment using body gestures and/or controllers. Some of the objects that a user can also interact with are real (real-world) objects, which exist independently of the computer system controlling the artificial reality environment. For example, a user can select a real object and add a virtual overlay to change the way the object appears in the environment. While there are some messaging systems that can be provided by artificial reality devices, such messaging tends to be presented as standalone virtual objects (e.g., a 2D panel in a 3D space) that a user can bring up or pin to a location and a sending side of the communication thread is unaware of where and how messages are presented.

### SUMMARY

Aspects of the present disclosure are directed to an avatar reaction system in which messaging (e.g., text, audio, video) can be initiated via an avatar. For example, an avatar placed in a user's environment can be a representation of another user, and when a control in relation to the avatar is activated, a message with the represented avatar can be initiated. On the receiving end, an avatar representing the sending user can also exist, providing a representation of the received message. When such a message is received via an avatar, a sentiment analysis can be performed on the message to identify one or more sentiments. Using a mapping of sentiments to avatar reactions, the avatar through which the message was received can perform the reaction, illustrating to the message sentiment.

Aspects of the present disclosure are directed to automated controls for connecting a trigger performed in an artificial reality environment to an action on a personal computing device.

Aspects of the present disclosure are directed to adding a like to a gesture target based on interpreting a like gesture. Various artificial reality (e.g., VR, AR, MR) devices can recognize user hand gestures. For example, some such devices can capture images of a user's hand, interpret input from a wearable device, etc., to determine a hand gesture, where a “gesture” can include either or both of a hand posture or hand movement. One or more of these hand gestures can be mapped as a “like” gesture. When a gesture-to-like system identifies such a like gesture, it can identify a gesture target of the like gesture. For example, the gesture-to-like system can identify a gesture target based on one or more of: a direction indicated by the user's hand when making the gesture, a direction indicated by the user's gaze when making the gesture, and/or other current or recent interactions performed by the user (such as which real or virtual objects with which the user has recently interacted). In response to recognizing the like gesture and identifying a gesture target, the gesture-to-like system can add a “like” to the gesture target, the form of which can depend on a type of the gesture target.

Aspects of the present disclosure are directed to administering a conversation thread, for a game, over a messaging platform. In-person games tend to be more about the social interaction between the participants than the mechanics of making game moves. While many computerized games have communication features built-in, they have failed to maintain this social interaction as the primary focus of the game. A conversation-based gaming platform disclosed herein can integrate game triggering events (e.g., completing a turn, achieving a goal, timer expiration, etc.) into a communication thread, thereby providing a gaming experience that evolves from social interactions, instead of merely providing communication mechanisms as a secondary feature of a game.

Aspects of the present disclosure are directed connecting a game with a conversation thread to coordinate game challenges. In-person games tend to be more about the social interaction between the participants than the mechanics of making game moves. While many computerized games have communication features built-in, they have failed to maintain this social interaction as the primary focus of the game. A score challenge gaming platform disclosed herein can integrate a game with a communication thread such that game milestones (e.g., game completion, level completion, score threshold, boss defeat, etc.) achieved by a first player can be shared with conversation thread participants and linked to the game, to challenge other thread participants to best a value associated with the game milestone of the first player.

Aspects of the present disclosure are directed to establishing a shared space for a 3D call with participants' hologram representations mirrored as compared to how images of the participants are captured. A shared space for a 3D call can have various items such as 3D models, a shared whiteboard, documents, etc. For example, a shared space may have a semi-transparent whiteboard that both 3D call participants can write to. However, this whiteboard should not be reversed for either participant even when the participants are facing each other, so the whiteboard should be displayed from the front to both participants. Normally, this would create a problem that if one participant is pointing at a part of the whiteboard, the other participant sees them pointing to a different part. However, by presenting the holographic representation of the participants as mirrored (as compared to how each participant is captured by a capture device) the holographic participant's spatial movements are correct when viewed by the other participant. In addition, the shared space can be enabled or disabled according to certain modes (e.g., disabling the shared space upon detecting that the capture device is moving above a certain speed or has been turned off) and the shared space can be dynamically sized according to the content placed within it or manually sized by a participant.

Aspects of the present disclosure are directed to scanning a physical 3D space to onboard it as a messaging inbox and providing the scanned 3D space for delivery point selection to a message sender. A spatial messaging system can accomplish this by allowing a recipient user to establish one or more physical spaces as messaging inboxes, which the spatial messaging system can facilitate with various depth-scanning techniques and input flows for a user to specify a region as the inbox. The spatial messaging system can also provide a representation of the messaging inbox (e.g., as an image or 3D mesh) to a sending user, allowing the sending user to select a delivery point for a 3D message within the area designated as a messaging inbox. Upon delivery of the 3D message to the messaging inbox, in some cases, the spatial messaging system can display it as a minimized virtual object (referred to herein as a “glint”) once a recipient user is in the area. The recipient user can then make a selection to maximize the virtual object to see the full message. In some cases, no notification of the message is provided to the recipient until the recipient is in the vicinity of the messaging inbox.

### BRIEF DESCRIPTION OF THE DRAWINGS

FIG. 1 is an example of an avatar reacting with a fist-pump to an excited sentiment in a text message.

FIG. 2 is an example of an avatar reacting with a dance to a happy sentiment in a voice message.

FIG. 3 is an example of multiple avatars grouped in response to the avatar owners being physically co-located.

FIG. 4 is a flow diagram illustrating a process used in some implementations for determining a sentiment of a message sent via an avatar and providing a mapped avatar reaction.

FIG. 5 illustrates an example of an artificial reality environment in which multiple users are collaborating.

FIG. 6 illustrates an example of the artificial reality environment in which a user is importing images from her laptop without leaving the artificial reality environment.

FIG. 7 illustrates an example of the artificial reality environment in which an image has been imported into the artificial reality environment.

FIG. 8 is a flow diagram illustrating a process used in some implementations for triggering, from an artificial reality (XR) device, an action on a personal computing device.

FIG. 9 is an example of a user interacting with a conversation thread in an artificial reality environment provided by an artificial reality device.

FIG. 10 is an example of the artificial reality device adding a like icon as a message in the thread.

FIG. 11 is an example of a user interacting with a virtual object in an artificial reality environment provided by an artificial reality device.

FIG. 12 is an example of an artificial reality device of the user who shared a virtual object, adding a like icon to the sharing user's version of the virtual object.

FIG. 13 is a flow diagram illustrating a process used in some implementations for adding a like to a gesture target.

FIG. 14 is an example of a user interface for a turn-based game, where a first player makes selections in his turn then sends his move to a second player via a conversation thread.

FIG. 15 is an example of the conversation thread between the first player and second player.

FIG. 16 is an example of capturing a player image and selecting AR effects for inclusion in a captured game state following a transition trigger.

FIG. 17 is a flow diagram illustrating a process used in some implementations for administering a conversation thread, for a game, over a messaging platform.

FIG. 18 is an example of selecting recipients for a game challenge.

FIG. 19 is an example of customizing a self-image to include with a game challenge message.

FIG. 20 is an example of a conversation thread with a game challenge message.

FIG. 21 is an example of a conversation thread with a game challenge result and a link to repeat the game challenge.

FIG. 22 is a flow diagram illustrating a process used in some implementations for connecting a game with a conversation thread to coordinate game challenges.

FIG. 23 is an example of a participant specifying a size for a shared space for a 3D call.

FIG. 24 is an example of an initialized 3D call with a shared space containing a whiteboard.

FIG. 25 is an example of an initialized 3D call with a shared space containing a volume with shared 3D models.

FIG. 26 is a flow diagram illustrating a process used in some implementations for establishing a 3D call with a shared space.

FIG. 27 is an example of scanning a real-world space as a messaging inbox.

FIG. 28 is an example of selecting a delivery point, in a scanned real-world space, for a 3D message.

FIG. 29 is an example of receiving a 3D message at a delivery point in a scanned real-world space.

FIG. 30 is an example of receiving a 3D message as an expandable glint at a delivery point in a scanned real-world space.

FIG. 31 is a flow diagram illustrating a process used in some implementations for scanning a physical space to onboard it as a messaging inbox.

FIG. 32 is a flow diagram illustrating a process used in some implementations for providing a scanned 3D space for a message sender to select a delivery point.

FIG. 33 is a block diagram illustrating an overview of devices on which some implementations of the disclosed technology can operate.

FIG. 34 is a block diagram illustrating an overview of an environment in which some implementations of the disclosed technology can operate.

### DESCRIPTION

An avatar reaction system can analyze messages received in relation to an avatar existing in a recipient user's environment and cause the avatar to have a reaction to a determined sentiment of the message. For example, the avatar can be a representation of the user who sent the message, and the reaction can demonstrate the sentiment of the sending user, making the avatar more realistic, engaging, and expressive. The avatar reaction system can determine the sentiment of the message by performing various natural language processing techniques such as voice to text, parts of speech tagging, audio tone to emotion mapping, phrase to sentiment mapping, etc. The avatar reaction system can then apply a user-defined or automated mapping of sentiments to avatar reactions to select a reaction matching the sentiment. The avatar reaction system can apply the avatar reaction to the avatar of the sending user existing in the artificial reality environment of the recipient user.

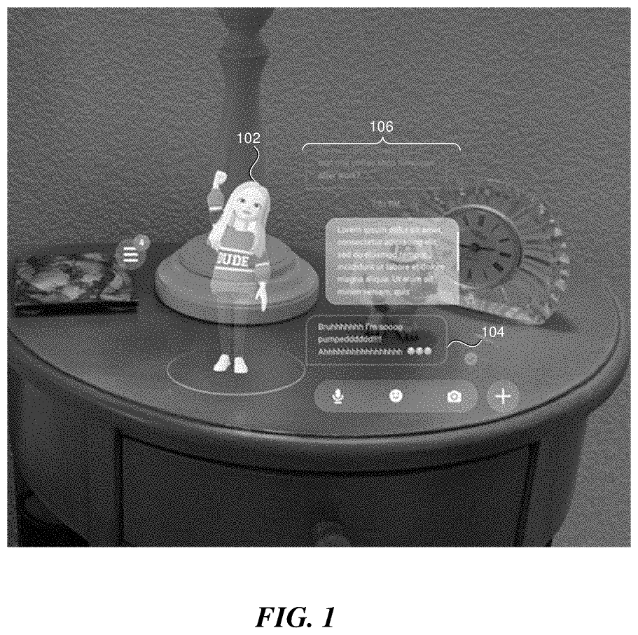

FIG. 1 is an example 100 of an avatar reacting with a fist-pump to an excited sentiment in a text message. In example 100, a recipient user (not shown) has placed an avatar 102 in her environment (making it an artificial reality environment) on a side table. The avatar 102 is a representation of the recipient user's sister (also not shown). The user and the user's sister have an ongoing text conversation 106. When message 104 is received from the user's contact in relation to the avatar 102, a sentiment of “excited” is determined for the message. This sentiment is mapped to an avatar fist-pump reaction, which the avatar 102 then performs.

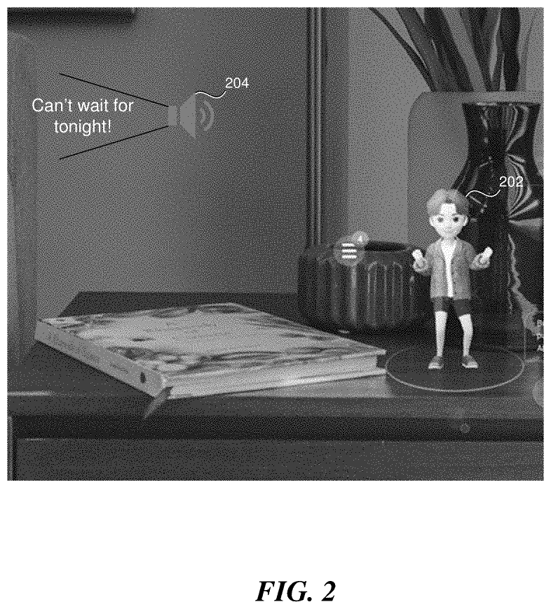

FIG. 2 is an example 200 of an avatar reacting with a dance to a happy sentiment in a voice message. In example 200, a recipient user (not shown) has placed an avatar 202 in her environment on a coffee table. The avatar 202 is a representation of the recipient user's contact (also not shown). The user has engaged a voice call with the contact by looking at the avatar 202 for a threshold amount of time (3 seconds in example 202). When audio message 204 is received from the contact in relation to the avatar 202 (illustrated as text connected to an audio icon to demonstrate audio in this drawing), a sentiment of “happy” is determined for the message. This sentiment is mapped to an avatar doing a dance action, which the avatar 202 then performs.

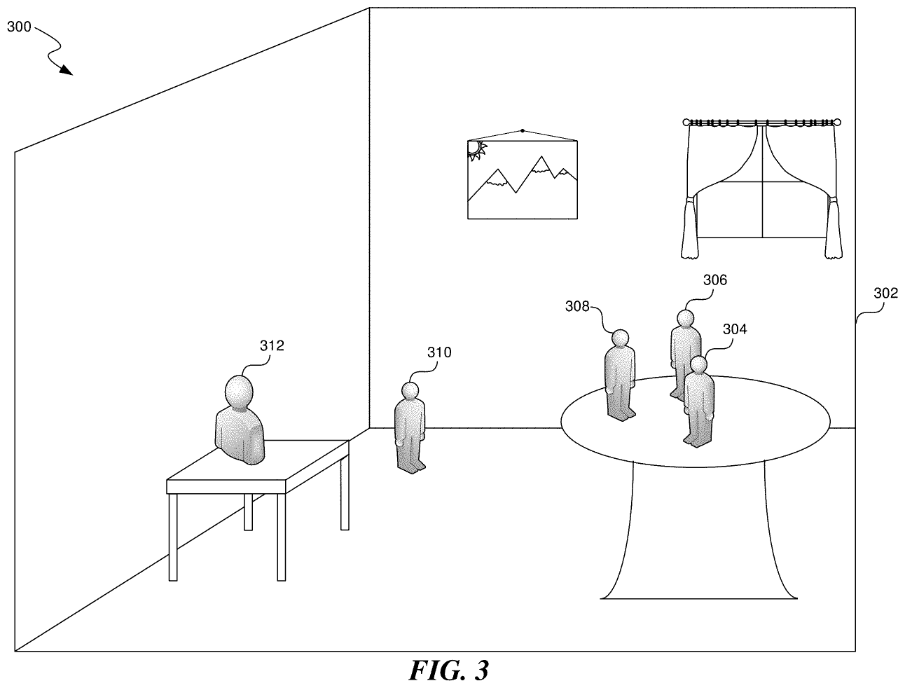

FIG. 3 is an example 300 of multiple avatars grouped in response to the avatar owners being physically co-located. Example 300 illustrates an artificial reality environment 302 in which a user has placed five avatars 304-312 representing different users. These users sometimes provide location information (e.g., check-ins at various locations). In example 300, the users represented by avatars 304-308 have all checked-in to the same location. In response, the avatars 304-308 representing these users have moved to be near each other in the artificial reality environment 302. The avatars 310 and 312 who have not indicated co-location with the other users have not moved to be grouped with avatars 304-308. Such live avatars can provide various representants of location, emotion, or other status indicators provide by the users the avatars represent.

Thus, FIG. 3 illustrates a process whereby a system can receive information specifying real-world physical locations of multiple users who are each represented by an avatar in an artificial reality environment; identify at least two of the real-world physical locations as matching each other (e.g., check-in to the same building, establishment or evet; being within a threshold distance of one another; etc.); and in response to the identifying, causing the avatars, representing the users whose real-world physical locations match, to be grouped, wherein the location of the group of avatars is not based on real-world positions of the represented users.

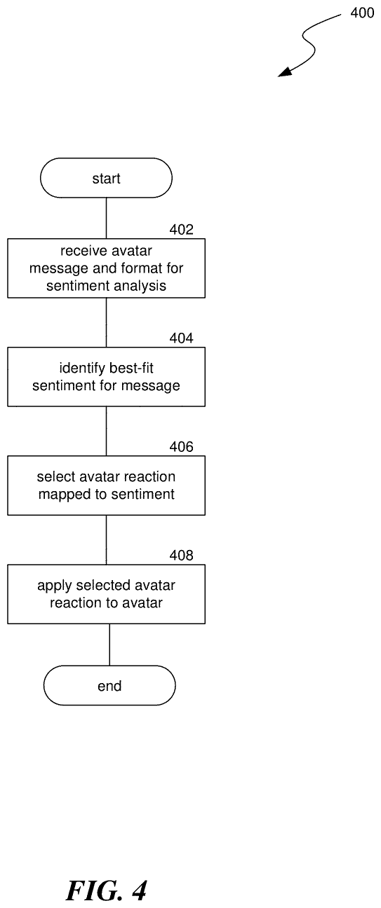

FIG. 4 is a flow diagram illustrating a process 400 used in some implementations for determining a sentiment of a message sent via an avatar and providing a mapped avatar reaction. In some implementations, process 400 can be performed on an XR device providing avatar projections or a server system acting as an intermediary for communications via avatars and instructing XR devices on how to animate the avatars for messaging reactions. In some implementations, process 400 can be performed in response to a new message being sent via an avatar.

At block 402, process 400 can receive a message via an avatar, in an artificial reality environment, and format the message for sentiment analysis. In some implementations, the message can be sent via another avatar. For example, the message can be initiated by a user activating a control related to an avatar, the user proving a spoken command to the avatar, process 400 determining that the user's gaze has been directed at the avatar for a threshold time, etc. In some implementations, messages can be received via an avatar but may have been sent through another process. For example, a text message can be sent from a user's mobile phone, and that message can be received at an avatar representation of the sending user, placed in an artificial reality environment, by the recipient to represent the sending user. The message can be provided, e.g., as spoken natural language, text input, a video, a gesture, etc.

On the receiving end, an avatar representing the sending user can provide a representation of the received message. Process 400 can format this message for sentiment analysis, such as by converting non-text natural language from audio or video input to text (e.g., natural language processing—“NLP”), identifying user poses or body postures in image or video input, or identifying user tones in audio input. This text and, if available, other identifiers can be formatted for input to a sentiment identification engine. For example, the sentiment identification engine can be a neural network or other machine learning model trained to receive text and any of these other identifiers (e.g., as items in a sparse vector) and map them to a sentiment. At block 402, process 400 can generate this machine learning input.

At block 404, process 400 can identify a best-fit sentiment for the message received at block 402. In various implementations, this can include using a mapping of keywords identified at block 402 to sentiments; applying machine learning input from block 402 to a machine learning model that produces a sentiment identifier; identifies phrases most similar to the input text that have been mapped to sentiments, etc. Examples of sentiments that may be identified at block 400 include: emotions such as happy, sad, angry, etc.; responses such as like, love, surprise, shock, bored, confused, curious, amused, etc.; person actions such as crying, laughing, clapping, dancing, kissing, partying; or other sentiments such as tired, lonely, in love, excited, zany, etc.

At block 406, process 400 can select an avatar reaction mapped to the sentiment identified at block 404. Avatar reactions can include a variety of changes to the avatar such as setting an avatar facial expression, changing how much of the avatar is shown, changing the avatar's size, having the avatar perform a movement, creating a virtual object for the avatar (e.g., avatar accessory such as a crown, heart animation, rain-cloud, etc.), causing the avatar to interact with a virtual object or a real object in the artificial reality environment, etc. In some implementations, various avatar reactions can be created and manually mapped to particular sentiments. In other implementations, reactions can be mapped according to a machine learning model that is trained on pairings of determined user sentiments to user-selected reactions (e.g., adding an AR effect). In yet further cases, users can select their own mappings for sentiments to avatar reactions that avatars representing them should have. In some implementations, a XR system can monitor user sentiments (e.g., via messaging, voice tone, etc., as discussed in relation to block 404) while also identifying how the user reacts to those sentiments (e.g., identifying physical movements, natural language reactions, selected emoji reactions, etc.). Based on these observations, the XR system can automatically identify parings of user sentiments to user reactions, which can be translated to avatar reactions. Thus, the XR system can use an automatically generated mapping that causes the avatar to mimic how the user would react to the identified sentiment. In some cases where an identified sentiment is not mapped to an avatar reaction, the sentiment can be mapped into a semantic space for sentiments, some of which have been mapped to avatar reactions. Using a cosine distance analysis, the identified sentiment can be matched to a sentiment with a reaction base on it being the closest in the semantic space.

At block 408, process 400 can apply the avatar reaction selected at block 406 to the avatar. As discussed above, the avatar reaction can include various avatar changes such as setting an avatar facial expression, changing how much of the avatar is shown, changing the avatar's size, having the avatar perform a movement, creating a virtual object for the avatar, causing the avatar to interact with a virtual object or a real object in the artificial reality environment, etc. At block 408, these changes selected at block 406 can be implement for the avatar through which the message was received at block 402. Process 400 can then end.

When working in an artificial reality environment, especially fully immersive ones such as those provided by virtual reality systems, users can find it troublesome to switch between interactions with the XR device and other personal computing devices (e.g., laptop, desktop, mobile phone, etc.) For example, a user may want to access files on her laptop while in a VR meeting or send an image from her phone to her mixed reality headset. However, such actions can require the user to remove the XR device to be able to access controls for the personal computing device and/or perform a complicated series of actions on the personal computing device to send the relevant information to the XR device.

A cross-surface intent system disclosed herein allows triggers recognized by the XR device, such as gestures, activating UI controls, spoken commands, entering a given space, etc., to cause an action on another device linked to the XR device. The cross-surface intent system can include a set of mappings of XR triggers to personal computing device actions. In various implementations, the mappings can be user customizable, context-specific, and/or parameter driven. For example, a user may be able to set new mappings, define rules for how action should occur when the XR device or personal computing device recognizes various contexts, or provide variations for an action depending on parameters passed to it when the corresponding trigger is activated. In various implementations, the actions on the personal computing device can include, for example, opening a web browser to a particular website, making an API call, executing a given script or application, performing a series of UI inputs, sending a message or sharing content with a given recipient (e.g., participants of a current shared artificial reality environment), etc.

Some artificial reality (XR) systems allow users to interact with their personal computing devices though a “remote desktop,” providing the ability for the user to interact with the personal computing device while in the artificial reality environment provided by an XR system. In some implementations, one or more of the mappings of the cross-surface intent system can include a trigger mapped to initiating a remote desktop connection with a personal computing device, which can bring up the personal computing device's display in the artificial reality environment. This allows the user to interact with the personal computing device without having to take off her XR device or interact with controls of the personal computing device. In some cases, the trigger can further be mapped to automated actions on the personal computing device such that when the remote desktop connection is initiated, workflows, content items, social interactions, etc. are queued up, allowing the user to easily perform relevant actions.

For example, a first UI button in the artificial reality environment can be a trigger for an image import flow on the personal computing device, such that activating the first UI button causes the remote desktop to be displayed and the personal computing device to open a web portal for uploading images from the personal computing device to a shared whiteboard in the artificial reality environment. In this example, with a single virtual button click while a user is in a VR collaboration, she can access an interface to select images or other content saved on her laptop and share it with the collaboration participants. As another example, a second UI button in the artificial reality environment can be a trigger for an participant invite flow on the personal computing device, such that activating the second UI button causes the remote desktop to be displayed and the personal computing device to make an API call to a calendar application, opening an invitation widget pre-loaded with invite information for the VR collaboration in which the user is participating. In this example, with a single virtual button click while in the VR collaboration, the user can reach an interface to ask other users to join her in the VR collaboration.

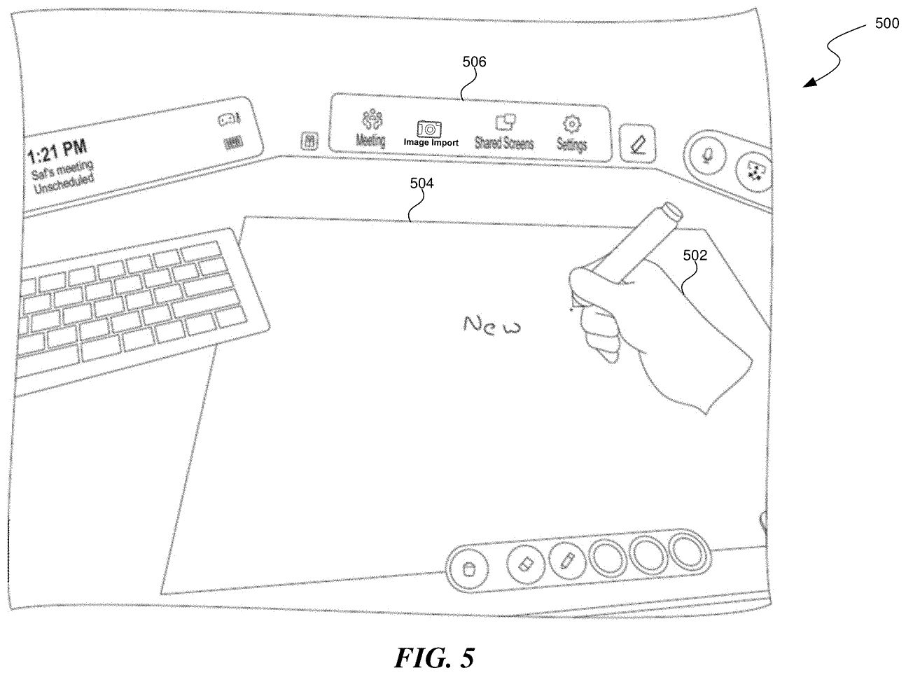

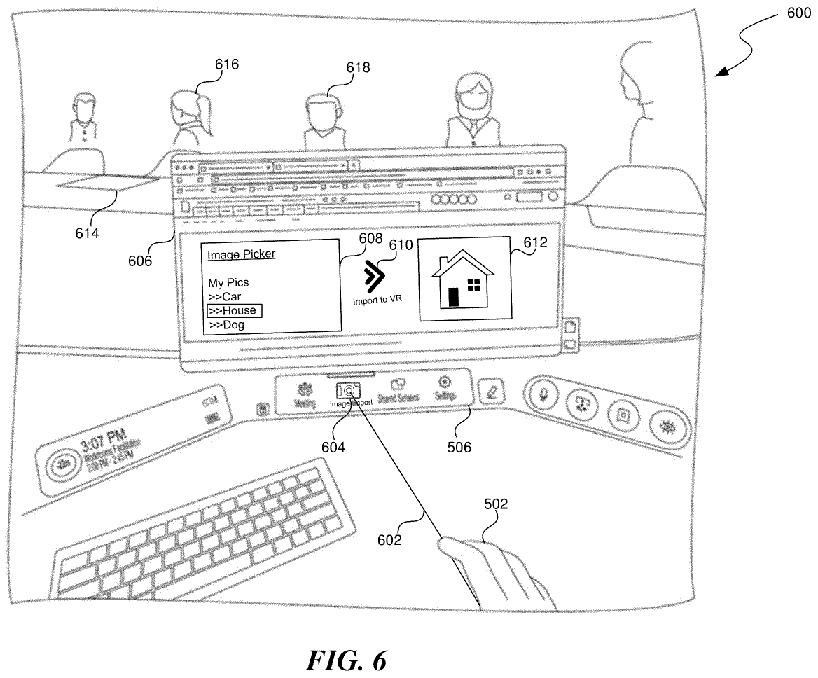

FIG. 5 illustrates an example 500 of an artificial reality environment in which multiple users are collaborating. In example 500, a user 502 is working on a shared workspace 504, which is mirrored to a shared whiteboard (not shown) and other workspaces (such as workspace 614 in FIG. 6) that multiple other users (such as users 616 and 618 in FIG. 6) in the collaboration can view. The user 502 has access to various controls, such as controls 506, allowing the user to take actions such as setting up screen sharing, performing an image import, accessing settings, etc.

FIG. 6 illustrates an example 600, continuing example 500, of the artificial reality environment in which a user is importing images from her laptop without leaving the artificial reality environment. In example 600, the user 502 has made a gesture causing a ray 602 to be cast from her hand, which she directs at controls 506. The user 502 uses the ray 602 to select the image import button 604. Image import button 604 is mapped to an action to: initiate a remote desktop with the user 502′s laptop, open a web browser on the laptop, and direct the web browser to an image import widget that can load images from the user 502′s laptop into the artificial reality environment. Activating button 604 causes the XR device controlling the artificial reality environment to connect to an action service on the user 502′s laptop and begin remote desktop session 606 which is showing the image import widget, including an image picker 608 and a control 610 to import a selected image (in this example house image 612) into the artificial reality environment.

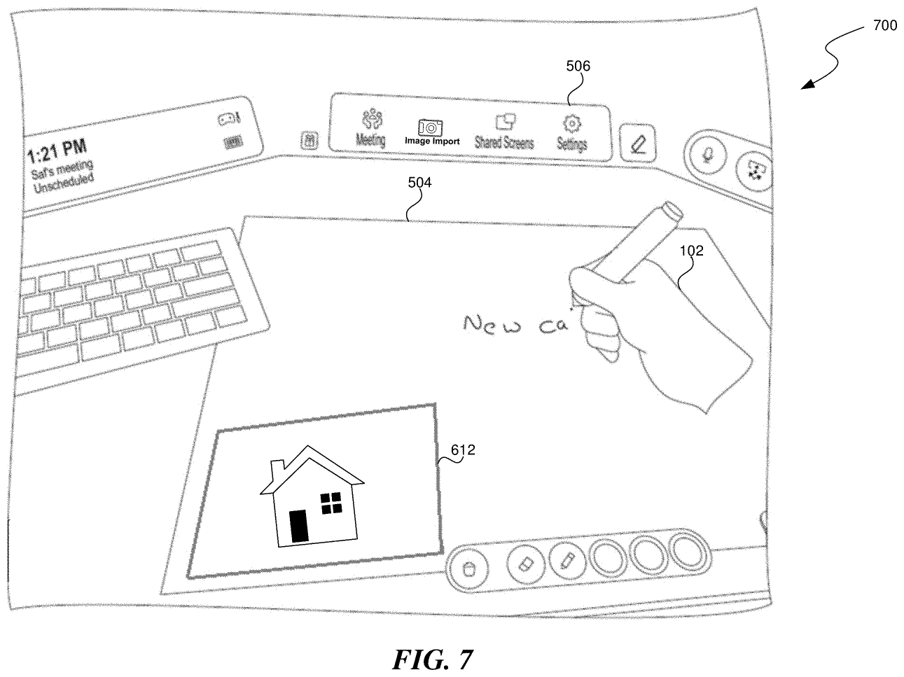

FIG. 7 illustrates an example 700, continuing examples 500 and 600, of the artificial reality environment in which an image has been imported into the artificial reality environment. In example 700, image 612 has been automatically added to the workspace 504, from the user 502′s laptop as a result of the image import workflow performed through the remote desktop.

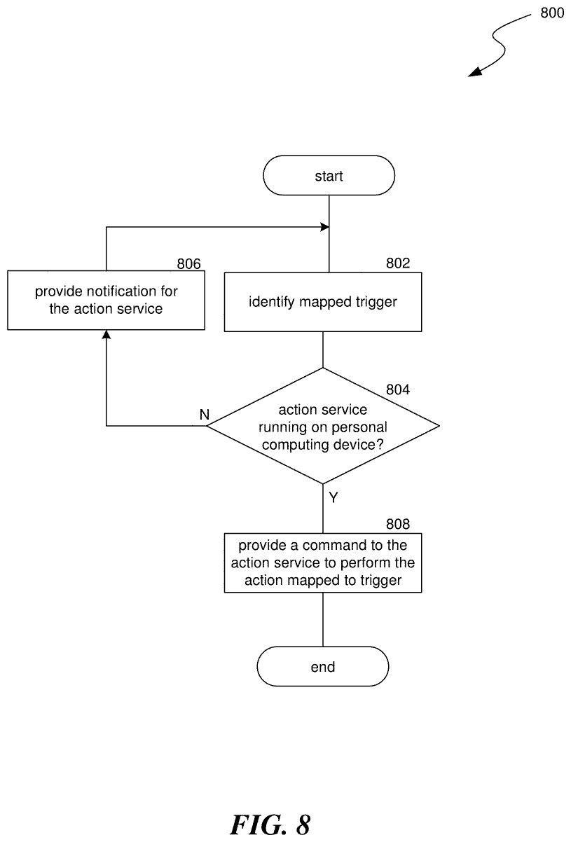

FIG. 8 is a flow diagram illustrating a process 800 used in some implementations for triggering, from an artificial reality (XR) device, an action on a personal computing device. In some implementations, process 800 can be performed in response to the XR device being initiated or entering a particular mode, such as when a user loads a program with mappings of triggers to personal computing device actions.

At block 802, process 800 can identify a trigger mapped to a personal computing device action. The trigger can be any event or sequence of events recognizable by the XR device (e.g., via cameras, microphones, input devices, etc.) such as a user making a gesture, pointing with a controller, performing a voice command, interacting with a UI element, entering a specified artificial reality environment volume, etc. The action mapped to such a trigger can include any action that can be caused on a personal computing device by a service action, such as making an API call, staring an application, directing an application to perform an action (such as directing a browser to open a given URL), sending a request for an action to the personal computing device operating system, emulating a sequence of user inputs, etc. In some implementations, different triggers can be mapped to actions on different personal computing devices. For example, a spoken command can trigger an action to access a URL via a user's mobile phone while pressing a virtual button can trigger an action to start a remote desktop connection with the user's laptop.

At block 804, process 800 can attempt to connect to an action service application of the personal computing device for the action mapped to the trigger identified at block 802. This connection can be established with predefined connection parameters, such as using an IP address of the personal computing device or by virtue of a user identifier for the current user being mapped by a service provider to application identifiers for given devices. In various cases, the connection can be a direct network connection, a connection via a third party (e.g., vis a server of a platform), or by a location connection such as a local area network, a Bluetooth connection, etc. If the connection to the action service is made, process 800 can continue to block 804; otherwise process 800 can continue to block 806.

At block 806, process 800 can provide a notification in relation to the action service, such as that a connection to the personal computing device for the action is not available, a suggestion to execute the action service on the personal computing device, that the action service cannot perform the indicated action at this time, etc.

At block 808, process 800 can provide a command to the action service to perform the action mapped to the trigger identified at block 802. For example, the action service can be configured with a set of actions, one of which can be indicated by process 800 for the action service to carry out. As another example, process 800 can provide a script or other set of operations for the action service to carry out. In various implementations, the action service can perform the action by, e.g., making an API call, executing a set of instructions, staring an application, directing an application to perform an action, sending a request for the action to the personal computing device operating system, emulating a sequence of user inputs, etc.

For example, the action can be to setup a remote desktop connection with the XR device. The application service can instruct the personal computing device operating system to connect to another monitor driver provided for the remote desktop connection. The personal computing device can then provide video output through that driver to display the video output in the artificial reality environment.

A gesture-to-like system can recognize a like gesture, identify a gesture target, and, in response, add a “like” to the gesture target. With an artificial reality device, the gesture-to-like system can recognize various gestures as a like gesture, such as identifying that the user performed a “thumbs up” gesture, an “OK” gesture, a “wave” gesture, etc. As discussed above, the gesture-to-like system can perform such identifications by recognizing the gesture in captured images of the user's hands and/or from sensors taking readings in relation to the user's hands.

The gesture-to-like system can identify the gesture target by determining one or more factors of the user's attention prior to or during the gesture. In some implementations, a gesture target factor can be a direction associated with the gesture itself (e.g., determining a line running out from the user's hand when making the gesture). In some cases, a gesture target factor can be where the user was looking when she made the gesture (e.g., based on cameras that monitor eye position and determine a direction of user gaze). In yet further cases, a gesture factor can be what real or virtual objects the user interacted with just prior to making the gesture (e.g., a thread the user was communicating in, an area designated for sharing through which the user had received a virtual object, an object the user had recently touched, etc.) In various implementations, the gesture-to-like system can use one or more of these factors to identify the gesture target. For example, the gesture-to-like system can determine a potential gesture target indicated by each of multiple of these factors and a confidence value for each and select the potential gesture target with the highest combined confidence factor. In various implementations, gesture targets for a like gesture can be, for example, a conversation thread provided through the artificial reality device or provided on another device recognized by the artificial reality device, an avatar of another user provided by the artificial reality device in an artificial reality environment, or an object (real or virtual) for which the object's status is accessible to one or more other users.

Once the gesture-to-like system has recognized the like gesture and identified a gesture target, the gesture-to-like system can add a like to the gesture target. In various implementations, a “like” can be a message in a conversation thread, a status on a message or object, and/or an action or animation provided by an avatar. Where the gesture target is a conversation thread provided through the artificial reality device, the gesture-to-like system can directly add a like to the conversation thread or to a particular message of the conversation thread. Where the gesture target is a conversation thread provided on another device, the gesture-to-like system can access the other device or an interface (e.g., API) of the messaging platform to add the like to the conversation thread. Where the gesture target is an avatar of another user, the like can include a corresponding avatar of the user who made the gesture, provided by an artificial reality device of the recipient user, making a similar like gesture, having an associated animation (e.g., a shower of hearts or smiley faces), or performing another action (e.g., doing a dance). Where the gesture target is an object with a shared status, the status can be updated to have the like, which can include adding a “like” icon to the object, notifying other users subscribing to the object's status, etc.

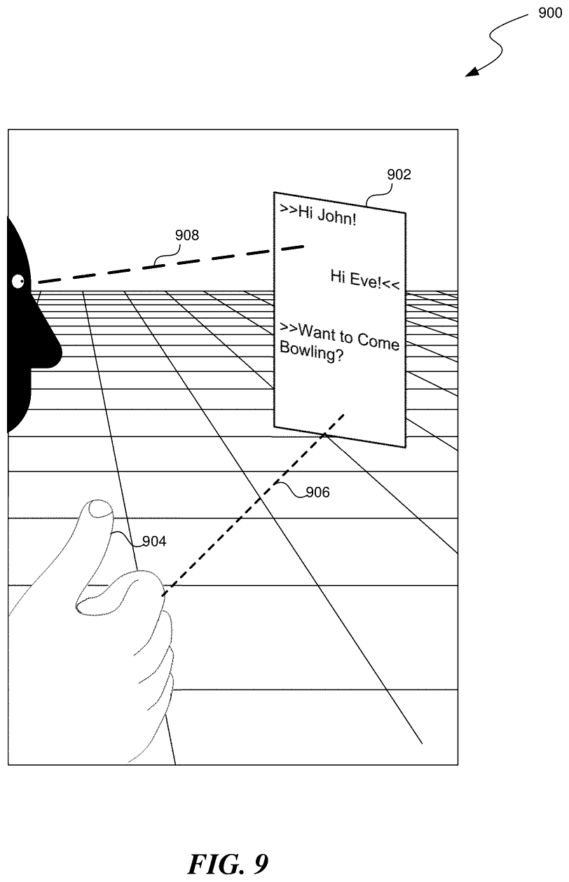

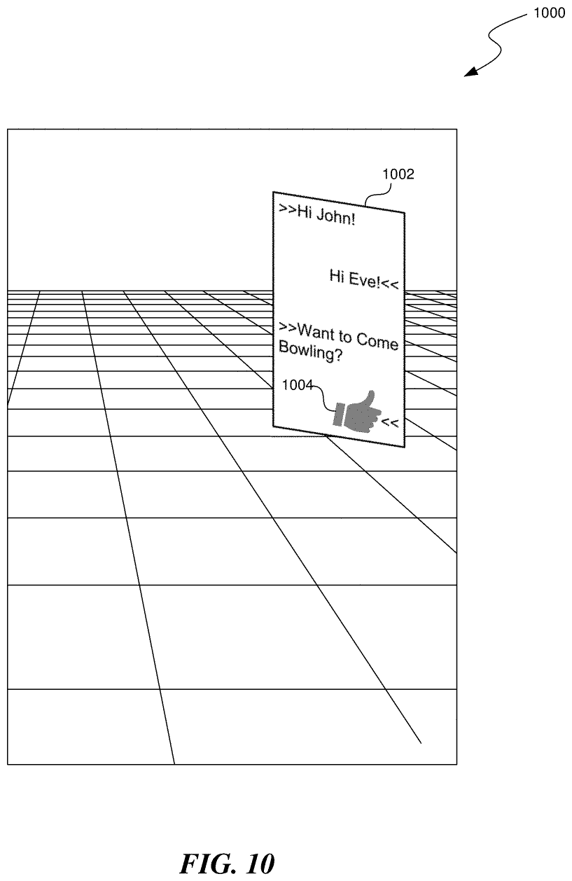

FIG. 9 is an example 900 of a user interacting with a conversation thread 902 in an artificial reality environment provided by an artificial reality device. In example 900, the artificial reality device is monitoring the user's hand poses, e.g., such as hand pose 904, and the user's eye gaze direction 908. Also in example 900, the artificial reality device has recognized that the hand pose 904 is a pose mapped as a like gesture. The artificial reality device also determines that the like gesture has a direction 906 which is toward conversation thread 902. The artificial reality device determines that, at the time the like gesture is recognized, the eye gaze 908 is also directed toward conversation thread 902. Based on these two determinations, the artificial reality device identifies that the gesture target, of the like gesture formed by pose 904, is the conversation thread 902. FIG. 10 is an example 1000 of the artificial reality device, following the determinations in example 900 of recognizing the like gesture and the gesture target, adding a like icon 1004 as a message in the thread 902, making it message thread 1002.

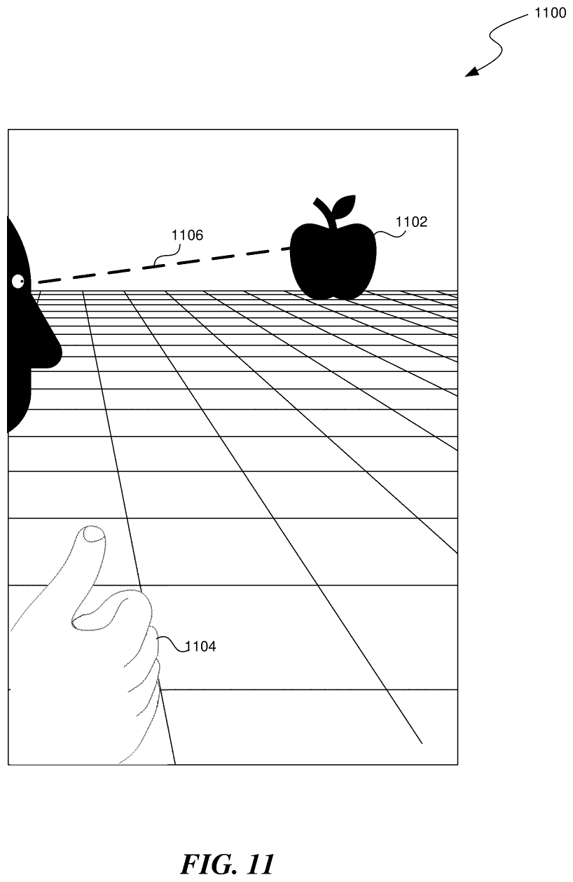

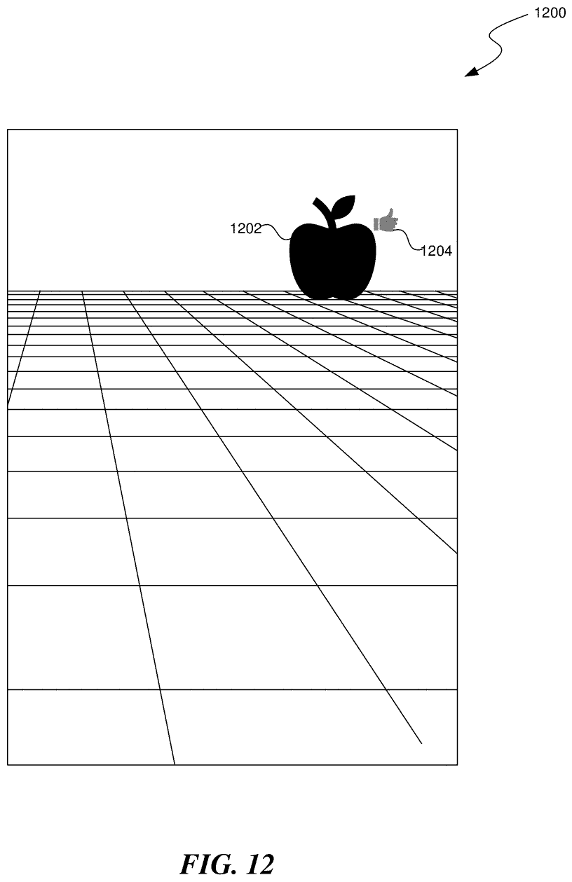

FIG. 11 is an example 1100 of a user interacting with a virtual object 1102 in an artificial reality environment provided by an artificial reality device. In example 1100, the virtual object 1102 has been shared by another user who has her own version (1202 in FIG. 12) of the virtual object 1102. Further in example 1100, the artificial reality device is monitoring the user's hand poses, e.g., such as hand pose 1104, and the user's eye gaze direction 1106. Also in example 1100, the artificial reality device has recognized that the hand pose 1104 is a pose mapped as a like gesture. The artificial reality device determines that the user recently (e.g., within a threshold time such as 3 seconds) interacted with the object 1102. The artificial reality device also determines that, at the time the like gesture is recognized, the eye gaze 1106 is directed toward virtual object 1102. Based on these determinations, the artificial reality device identifies that the gesture target, of the like gesture formed by pose 1104, is the virtual object 1102. FIG. 12 is an example 1200 of an artificial reality device of the user who shared the virtual object 1102, following the determinations in example 1100 of recognizing the like gesture of the recipient user and the gesture target, adding a like icon 1204 to the sharing user's version 1202 of the virtual object.

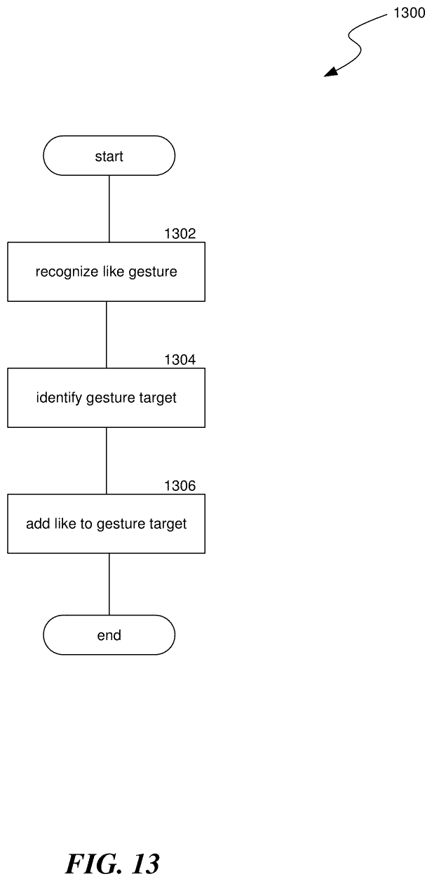

FIG. 13 is a flow diagram illustrating a process 1300 used in some implementations for adding a like to a gesture target. In some implementations, process 1300 can be performed on an artificial reality device or on a server system with input from an artificial reality device. In some cases, process 1300 can be initiated when an artificial reality device is powered on (e.g., as part of the artificial reality device operating system or a “shell” environment) or when the artificial reality device executes a particular program configured to provide likes for particular gestures.

At block 1302, process 1300 can recognize a like gesture. In various implementations, the like gesture can be a hand pose and/or movement such as a thumbs-up gesture, an index finger tip and thumb tip touching with other fingers splayed to form an OK gesture, etc. or a gesture by another body part such as a head nod or arm raised. In various cases, process 1300 can recognize the like gesture by analyzing images captured of parts of the user and/or by analyzing reading from a wearable device such as a glove or wrist band. In some cases, the image analysis and/or wearable device sensor data can be analyzed using a machine learning model trained to identify gestures or kinematic models of parts of the user that can be mapped to known gestures.

At block 1304, process 1300 can identify a gesture target. The gesture target can, for example, be a conversation thread provided by an artificial reality device performing process 1300, a conversation thread provided by another device that the artificial reality device performing process 1300 can recognize, an avatar of another user provided by the artificial reality device, an object with a status sharable with another user (e.g., a virtual object shared by another user, a landmark in the real-world, a location designated for sharing, etc.), or another real or virtual object. In some implementations, process 1300 can use one or more of various factors to identify the gesture target including a direction defined by the like gesture recognized at block 1302; a direction determined for the user's gaze when the user made the like gesture; or actions taken by the user, in relation to real or virtual objects, at or within a threshold time of making the like gesture. In some implementations, process 1300 can use a combination of these factors where each can have an assigned inherent accuracy value and/or instance-specific confidence value used to weight each factor in a combination, to select an overall highest valued gesture target.

At block 1306, process 1300 can add a like to the gesture target. Where the gesture target is a conversation thread provided through the artificial reality device, process 1300 can directly add a like to the conversation thread or a particular message of the conversation thread. Where the gesture target is a conversation thread provided on another device, process 1300 can access the other device or an interface (e.g., API) of the messaging platform to add the like to the conversation thread. For example, process 1300 can identify that the gesture target is a conversation thread on another device associated with the user of the artificial reality device and can access a messaging platform accessible on the artificial reality device, make a call to an API of the messaging platform with an ID of the user and/or conversation thread, send a local networking signal to the other device to add a like message, access an application installed on the other device to send the like message, etc. Where the gesture target is an avatar of another user, the like can include a corresponding avatar of the user who made the gesture, provided by an artificial reality device of the recipient user, making a similar like gesture, having an associated animation (e.g., a shower of hearts or smiley faces), or performing another action (e.g., doing a dance). Where the gesture target is an object with a shared status, the status can be updated to have the like, which can include adding a “like” icon to the object, notifying other users subscribing to the object's status, etc.

In some cases where the gesture target is a conversation thread, process 1300 can determine if the like is directed at a particular message in the thread, in which case the like can be attached to that particular message, or to the thread in general, in which case the like can be sent as a new message in the thread. In some implementations, process 1300 can make this determination based on whether a direction of the like gesture and/or user's gaze was directed at a particular message and/or whether the like gesture was made within a threshold time of receiving a message in the conversation thread (e.g., within two seconds). Once process 1300 has added the like gesture to the gesture target, process 1300 can end or resume monitoring for additional like gestures (to be recognized at block 1302).

Online games fail to provide the social aspect that users get from playing games in-person. In-person games are more focused on the ongoing conversation between the participants, rather than just the moves players are making. The conversation-based gaming platform disclosed herein can turn the gameplay experience around so that it's primarily a social experience that ties the player turns or other triggering events to a conversation thread. This is accomplished by providing persistency between the game and the conversation thread. For example, where a player takes a turn in a game, the conversation-based gaming platform can capture a game state at the end of that turn (possibly with other features such as a picture of the player who took the turn). The conversation-based gaming platform can match the game state to a conversation thread ID and store it in relation to the conversation thread ID. A messaging platform of the conversation-based gaming platform can then access the game state, format it using a template developed for the particular game and/or triggering event and add the formatted game state to the ongoing conversation thread. In some cases, the formatted game state can include a link in the thread so another player, when viewing the conversation thread, can easily jump from the conversation thread to her turn in the game. The link can include an ID for game and its corresponding persistent data, allowing the conversation-based gaming platform to take the user to the game engine when the link is activated.

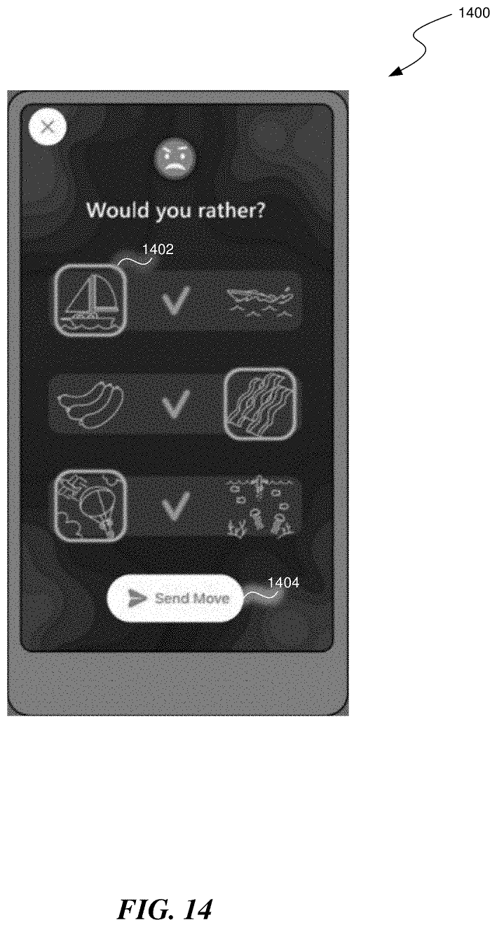

FIG. 14 is an example 1400 of a user interface for a turn-based game, where a first player makes selections in his turn then sends his move to a second player via a conversation thread. In example 1400, the first player's turn includes making selections of his preferences, such as selection 1402. These selections are included as part of a persistent game state, which is stored to a data store (e.g., a database) when the first player selects control 1404 (i.e., a transition trigger for the game in example 1400).

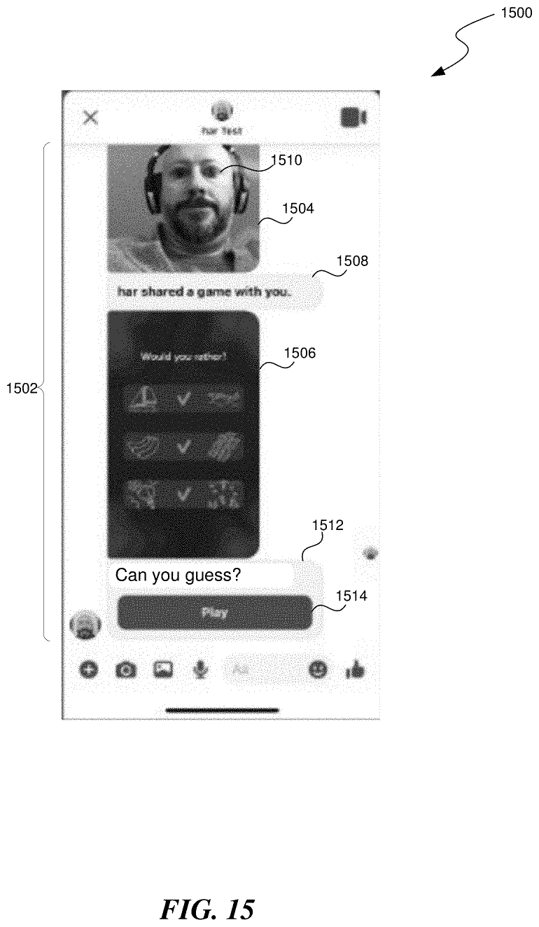

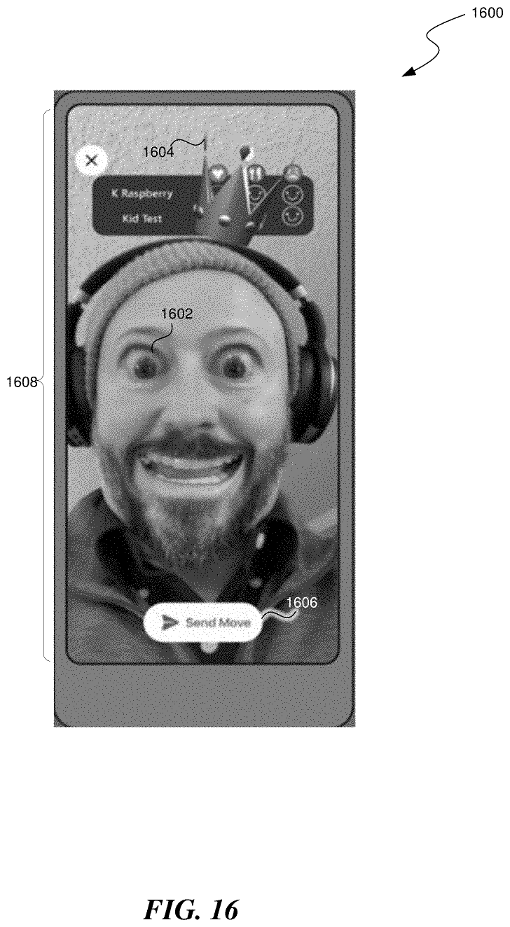

FIG. 15 is an example 1500 of the conversation thread 1502 between the first player and second player from example 1400. Following the selection of control 1404, the conversation-based gaming platform can capture a game state, which in example 1500 includes an image 1504 of the user who just completed the turn (discussed further below in relation to FIG. 16) and an indication 1506 of the game status, which in example 1500 includes a view of the choices the first player was offered in his turn without giving away what were the first player's selections (such as section 1402). The conversation-based gaming platform formats the image 1504 and indication 1506 into a template for the conversation thread—adding a “bug eyes” AR effect 1510 to the image of the user 1504 and setting the image 1504 as a first message; adding a canned string with specifics of the first user as a second message 1508; adding the indication 1506 as a third message; and adding a string with a link 1514 to the game as a fourth message 1512. The first through fourth messages are then sent by the conversation-based gaming platform over the conversation thread. Upon receiving the first through fourth messages, the second player can select the link 1514 to take her to a version of the user interface in example 1400 to continue the game. The players can repeat this process, including providing additional communication and sharing through the communication thread, while the game progresses.

FIG. 16 is an example 1600 of capturing a player image 1608 and selecting AR effects 1602 and 1604 for inclusion in a captured game state following a transition trigger. Example 1600 starts when a transition trigger has occurred (e.g., the first player has completed his turn) and is then asked to take a “selfie” to include in the conversation thread prompting the second player to rejoin the game. In example 1600, the first player has selected two AR effects: “bug eyes” 1602 and “crown” 1604 to apply to his image to be included in the conversation thread. Once the first player is satisfied with his image, he can select the “Send Move” control 1606 to have the conversation-based gaming platform save it with the rest of the game state to include in the conversation thread, as discussed above in relation to FIG. 15.

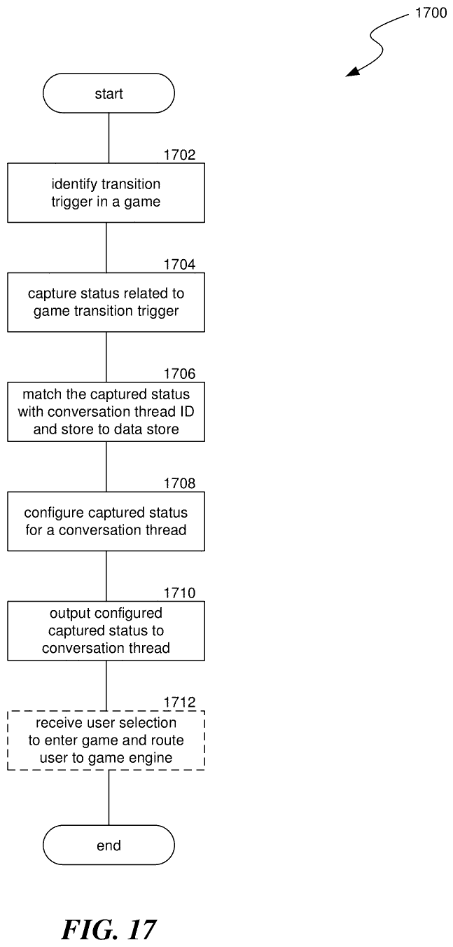

FIG. 17 is a flow diagram illustrating a process 1700 used in some implementations for administering a conversation thread, for a game, over a messaging platform. In some implementations, process 1700 can be performed on a server system, e.g., of a conversation-based gaming platform, coordinating an in-progress game and a conversation thread, with persistency between the two for asynchronous messaging and game play. In other implementations, versions of process 1700 can be performed on one or more client devices, that coordinate communications and game data to provide both the communication thread and game mechanics. In some implementations, process 1700 can be initiated when a game is started in association with a conversation thread, allowing an initial mapping between an ID of the game and an ID of the conversation thread to be formed—which is then relied upon for persistently storing and accessing data between the game and messaging platform. In some implementations, portions of process 1700 are performed by a game engine while other portions of process 1700 performed by a messaging platform, which may or may not be on the same computing system.

At block 1702, process 1700 can identify a transition trigger in a game. Different transition triggers can be defined for various games. For example, transition triggers for a particular game can include one or more of: completing a turn, a timer expiring, a player action (e.g., the playing pressing a “send move” or “poke other player” button), or a goal having been attained (e.g., a player reaching a score threshold, completing a level, unlocking a secret, acquiring an item, etc.) In some implementations, when an automated transition trigger occurs, the player can first be prompted to verify they want a message sent to other participants for that transition trigger.

At block 1704, process 1700 can capture a status related to the game transition trigger from block 1702. In various implementations, the status can include features of the game such as results of a turn, a game screenshot, an indication of a goal attained, etc.; and/or peripheral features such as an image of a player, virtual objects selected by the player, messages or recordings from the player, AR effects for the conversation thread either selected by the player or specified in a mapping of transition triggers to AR effects, etc.

At block 1706, process 1700 can match the captured status with a conversation thread ID and store the captured status to a data store in relation to the conversation thread ID. When a game is started it can be mapped to a conversation thread. For example, when a user starts a game a corresponding thread can be generated at the same time and the game ID can be mapped to the thread ID. As another example, a user may start a game by sending an invite for the game through an existing conversation thread, this process can include storing a mapping of the conversation thread ID to the ID for the new game. As yet another example, there may be an existing game and an existing thread, which one of the game participants can connect through a selection mechanism in the game or in the messaging platform to select the other thread/game, allowing the IDs of the game and thread to be mapped together and thus future transition triggers to be registered and sent through the conversation thread. Based on one of these mappings, process 1700 can lookup the conversation thread ID that is mapped to the current game, and store the game state, captured at block 1704, to a persistent data store, such as a database, a game state data structure (e.g., JSON blob, XML structure, etc.), a saved file, or in a message (e.g., the game state data structure formatted for TCP/IP packets) sent directly to the messaging platform.

At block 1708, process 1700 can configure the captured status, obtained from the data store of block 1706, for inclusion in the conversation thread. Process 1700 can first select a template for the captured status. In some cases, there is only one template while in others a template can be selected, from a set of templates that can format game states for the type of conversations thread, where the selection can be based on a mapping of the game (and in some cases a further sub-mapping for the transition trigger) to a template. In some implementations, the template selection can further be based on a filtering of eligible templates, e.g., those that accept portions of the captured game status from block 1704. In some cases, block 1708 can receive the game status (e.g., as a JSON object, XML block, meta-data tagged content items, etc.) and provide portions of it as parameters to the selected template for the conversation thread. In some implementations, block 1708 can also include applying automatically selected or user selected AR effects to portions of the game state, such as an AR effect added to an image of the user, an emoji added to a depiction of the game, a text or animation overlay, etc. For example, process 1700 could extract the user's face from their captured image and add it to a game character shown in an image of the game status. In various implementations, block 1708 can be performed by a game engine (e.g., following capturing the game state) or by a messaging platform (e.g., following receiving the stored the game state).

At block 1710, process 1700 can cause output of the captured status, as configured at block 1708, to the conversation thread. In various implementations, the conversation thread can be an instant messaging thread, a SMS or other phone text thread, an email thread, an artificial reality communication thread, a set of push notifications, etc. In various implementations, block 1710 can be performed by a game engine (e.g., by sending the configured game state to the messaging platform for delivery to the other conversation participants) or by the messaging platform having received and/or created the configured game state. In some implementations, the output message(s) in the conversation thread can include an indication of the game ID associated with game status, which in some cases can be used by a link in the output messages for a recipient user to access the game, as discussed below in relation to block 1712.

As discussed below, any block can be removed or rearranged in various implementations. However, block 1712 is shown in dashed lines to indicate there are specific instances where block 1712 is skipped. Where a link was included in the conversation output from block 1710, at block 1712, process 1700 can receive user selection to enter the game and route the user to the game engine based on the game ID provided in the configured captured status. For example, a link can be provided in one of the conversation thread messages or in relation to the conversation thread generally that, when activated, takes the activating user to the game engine to continue the game. This continuity of the game is based on the persistence of the game data that allows asynchronous game play. In some implementations, the activated link can be configured with an ID of the game, allowing process 1700 to open the game when the link is selected. In other implementations, the mapping discussed in relation to block 1706 can be consulted when the link is activated, allowing the current game ID to be determined based on the current conversation thread ID, and then allowing process 1700 to route the user to the game. As an example, one of the output messages in the conversation thread can include a button that, when activated, switches the activating user to the game, such as by calling a routine to switch to the indicated game application and load the game indicated by the game ID. With a simple transition from the conversation thread, the user can then take her turn, try and match the first player's achievement in the game, catch-up to where the first player left off, etc. In some implementations, when this second player reaches a transition trigger in the game, she is automatically returned to the conversation thread, while process 1700 is repeated to send an indication back to the first player.

Online games fail to provide the social aspect that users get from playing games in-person. In-person games are more focused on an ongoing conversation, rather than just the moves players are making. For example, an in-person communication may include a “watch this, bet you can't beat that” interaction, that online games fail to capture. The score challenge gaming platform disclosed herein can bring the gameplay experience back to a communication focus, so that it's primarily a social experience that ties milestones to a conversation thread challenging others to competitive play. This is accomplished by providing persistency between the game and the conversation thread. For example, when a player completes a milestone, the score challenge gaming platform can obtain selections from the player on who to send a challenge to, obtain a milestone value (e.g., final score, time taken to achieve the milestone, number of lives remaining, etc.) which the score challenge gaming platform can format into a challenge message for the conversation thread with a template, and send the challenge message to the selected recipients. In some cases, the challenge message can include a link in the conversation thread so the recipient, when viewing the conversation thread, can easily jump from the conversation thread to the game to try and best the milestone value. The link can include an ID for the game and its corresponding persistent data, allowing the score challenge gaming platform to take the second player to the game engine when the link is activated. When the second player reaches the milestone, the score challenge gaming platform can obtain a corresponding milestone value, which it can compare with the milestone value for the first player. Based on this comparison, another message can be formatted for the conversation thread showing the results of the challenge.

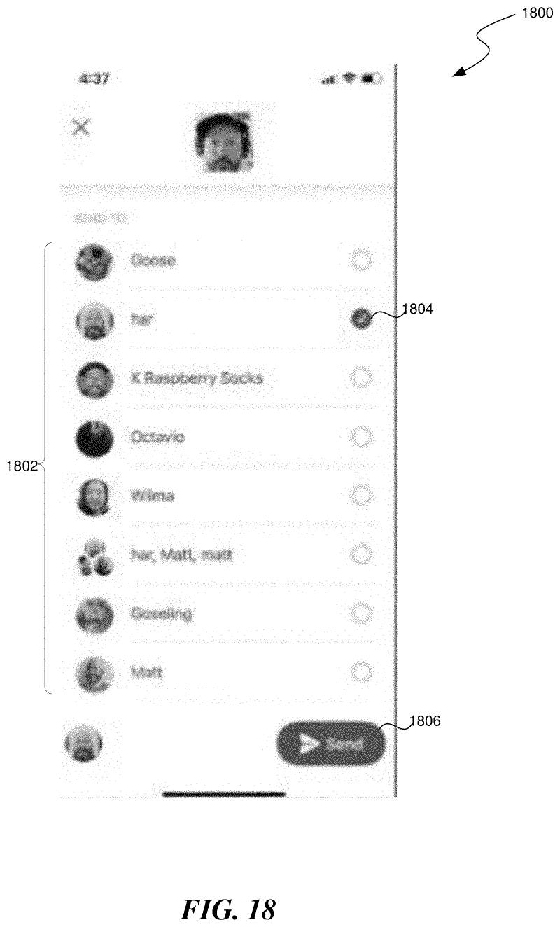

FIG. 18 is an example 1800 of selecting recipients for a game challenge. In example 1800 a first player has just completed a game milestone by completing a game. The first player selected an option to challenge friends to beat his score, which brought up a list of friends and ongoing conversations 1802. From this list 1802, the first player has selected 1804 a user to challenge as a second player in the game. Once the first player has made any additional selections he would like, he can select the “Send” button 1806, which will cause the score challenge gaming platform to format the challenge messages and send them to the selected other users.

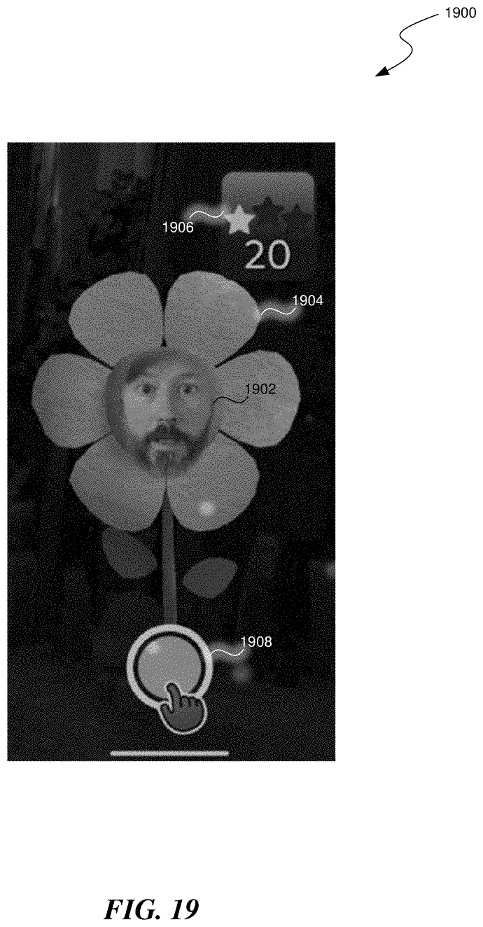

FIG. 19 is an example 1900 of customizing a self-image 1904 to include with a game challenge message. In example 1900, a player has decided to challenge other users to beat his score. A selected template for the challenge message includes a place for the user's image, so the score challenge gaming platform instructs the user to take a “selfie” 1902 to include in the challenge message. Example 1900 has put a portion of the user's image into a graphic 1904 from the game and shows the user's milestone value 1906 as a preview of the challenge message. When the user is satisfied with how his face looks in the challenge message, he can press control 1908 to complete it and send the challenge message to selected recipients.

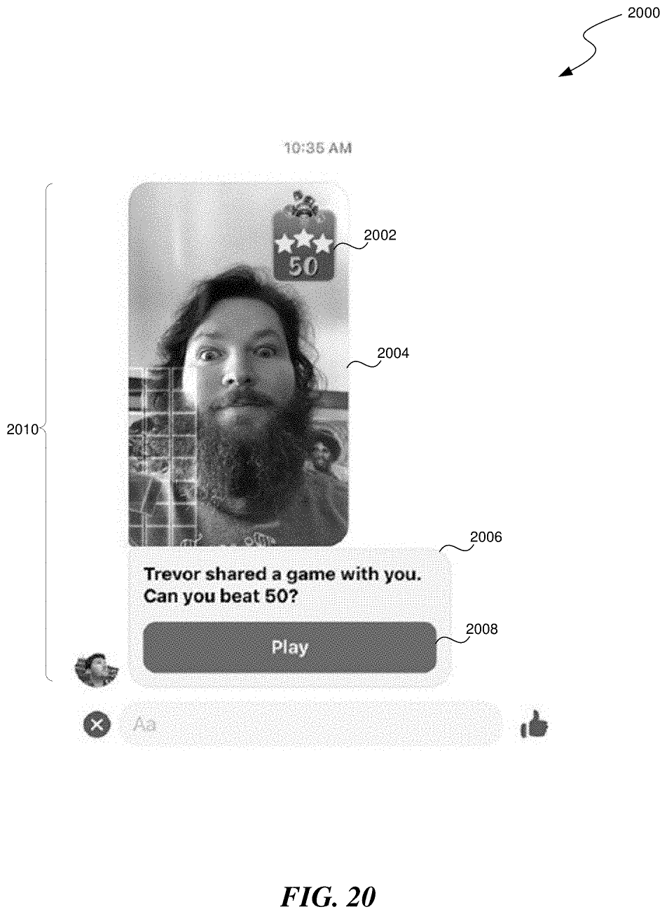

FIG. 20 is an example 2000 of a conversation thread 2010 with a game challenge message. In example 2000, a first player has completed a game (the milestone for this game) with a score of 50. The first player has decided to challenge his friend to try and beat this score and thus has selected the friend as a challenge recipient. In response, the score challenge gaming platform has created a challenge message including an image 2004 of the first player, an indication 2002 of the milestone value achieved by the first player, a pre-defined text 2006 challenging the selected recipient to play the game and beat the milestone value, and a link 2008 that, when activated, takes the user to the game associated with the challenge message in the conversation thread 2010.

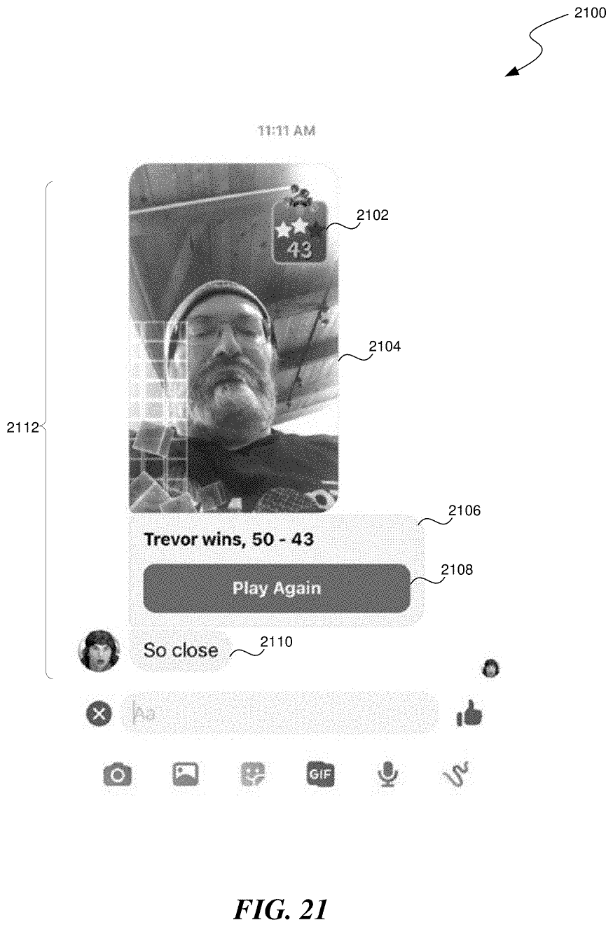

FIG. 21 is an example 2100 of a conversation thread 2112 with a game challenge result and a link 2108 to repeat the game challenge. In example 2100, a second player has accepted the challenge in example 2000 by activating the link 2008 and has played the game, achieving a score of 213. In response, the score challenge gaming platform has created the challenge result by capturing an image 2104 of the second player and including an overlay of his milestone value 2102 and providing a result 2106 of the challenge (retrieved based on the persistent data from the game played by the first player and mapped to the conversation thread ID) indicating that the first player achieved the higher score and providing a second link 2108, which either player can activate to repeat the challenge. The first player has also continued the conversation in the conversation thread by providing comment 2110 on the result of the first challenge.

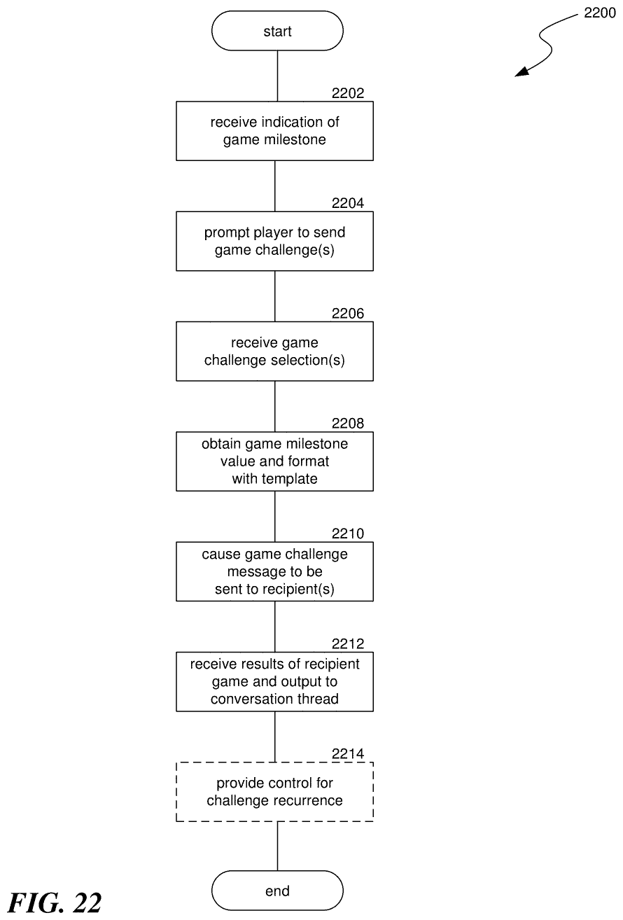

FIG. 22 is a flow diagram illustrating a process 2200 used in some implementations for connecting a game with a conversation thread to coordinate game challenges. In some implementations, process 2200 can be performed on a server system, e.g., of a score challenge gaming platform, connecting a game and a conversation thread, with persistency between the two for asynchronous messaging and game play. In other implementations, versions of process 2200 can be performed on one or more client devices, that coordinate communications and game data to provide the communication thread and game mechanics. In some implementations, process 2200 can be initiated when a game is started to watch for one or more pre-defined game milestones for creating a corresponding conversation thread. In other cases, process 2200 can be executed by the game as a result of reaching a particular milestone. In yet other cases, process 2200 can be stated through an existing conversation thread that can include a control for sending a game challenge. Performing process 2200 can create a mapping between a game ID and a conversation thread ID, e.g., when it initiates the game and/or conversation thread. This mapping can then be relied upon for persistently storing and accessing data between the game and conversation platforms. In some implementations, portions of process 2200 are performed by a game engine while other portions of process 2200 performed by a conversation platform, which may or may not be on the same computing system.

At block 2202, process 2200 can receive an indication of a game milestone. In various implementations, game milestones can be pre-defined or player selected events, specified as opportunities to challenge others. In some implementations, the milestones pre-defined for a game can include one or more of: when the game is completed, when a goal in the game is achieved (e.g., a player reaching a score threshold, completing a level, unlocking a secret, acquiring an item, etc.), an amount of playtime having been expended, etc. In some cases, a game milestone can occur when a player selects a control (e.g., a “challenge” button) that sets a milestone at the point in the game where the player currently is. Each game milestone can be associated with a milestone value as a measure of success in the game at that point. Examples of milestone values include a game score at the milestone; an amount of time it took the player to reach the milestone; an amount or number of lives remaining, an accuracy of moves, or other metric of skill in reaching the milestone; a rank achieved at the milestone; etc.

At block 2204, process 2200 can prompt player to send one or more game challenges. In various implementations, such prompts can include offering to the player to share the player's milestone value and/or requesting the player select one or more recipients. For example, process 2200 can provide a list of contacts, ongoing conversation threads, social media friends, etc., that the player can select from and/or an option for the player to enter a handle, email, or other identifier for other people the player wants to challenge. At block 2206, process 2200 can receive game challenge selection(s) from the player, such as a list of one or more recipients to challenge in relation to the game milestone.

At block 2208, process 2200 can obtain a game milestone value, and any other peripheral data, and format a challenge message with a template. As discussed above, a game milestone value can include any indication of success or skill in the game up to the point of the milestone, such as a game score at the milestone, an amount of time it took the player to reach the milestone, a metric of skill in reaching the milestone, a rank achieved at the milestone, etc. In some implementations, process 2200 can also obtain additional peripheral data such as a note from the player, a real-world image of the player or a virtual image of the player's avatar, social data for the player, etc.

In some implementations, a single template is available for challenge messages, e.g., filling in aspects such as a player name, photo, milestone value, etc. In other implementations, multiple templates can be available and process 2200 can select one based on a mapping of one or more of the milestone, available data, or contextual factors to the template. In some cases, the user can select from among a set of available templates for creating the challenge message. The game milestone value and any peripheral data can be added to the challenge message according to the selected template. In some implementations, block 2208 can also include applying automatically selected or user selected AR effects to portions of a challenge message or peripheral data, such as an AR effect added to an image of the user, an emoji added to a depiction of the game, a text or animation overlay, etc. For example, process 2200 could extract the user's face from their captured image and add it to a game character shown in an image of the game at the milestone.

At block 2210, process 2200 can cause the game challenge message to be sent to the recipient(s) via a conversation thread. In various implementations, the conversation thread can be an instant messaging thread, a SMS or other phone text thread, an email thread, an artificial reality communication thread, a set of push notifications, etc. In various implementations, block 2210 can be performed by a game engine (e.g., by sending the challenge message to the messaging platform for delivery to the other conversation participants) or by the messaging platform having received the milestone value and/or peripheral data and created the challenge message.

In some implementations, the output message(s) in the conversation thread can include an indication of the game ID of the game for which the challenge message was generated, which in some cases can be used by a link in the output messages for a recipient user to access the game. A recipient user selection of the link can route the recipient user to the game engine based on the provided game ID. For example, a link can be provided in one of the conversation thread messages or in relation to the conversation thread generally that, when activated, takes the activating user to the game engine to play the game up to the milestone. This relationship between the game milestone reached by the first player and the game play of this new second player is based on the persistence of the game data that allows asynchronous game play. As an example, the challenge message in the conversation thread can include a button that, when activated, switches the activating user to the game, such as by calling a routine to switch to the indicated game application and load the game indicated by the game ID. With a simple transition from the conversation thread, the new player can play the game attempting to reach the milestone and/or beat the first player's milestone value. In some implementations, when this second player reaches the milestone in the game, she is automatically returned to the conversation thread.

At block 2212, process 2200 can receive results of the second player's attempt at the game and output a results message to conversation thread. For example, the results message can indicate a comparison of the milestone values of the first and second players, whether one player was the winner (e.g., had a higher milestone value), any additions provided by either player (e.g., pictures, comments on the result, offers to try again, etc.), screenshots or notable moments from either player's attempt, etc. In some implementations, the results from one or both players can be added to a leaderboard for the game generally, which may be accessible via the conversation thread, an interface in the game, or another entry point.

As discussed above, any block can be removed or rearranged in various implementations. However, block 2214 is shown in dashed lines to indicate there are specific instances where block 2214 is skipped. At block 2214, process 2200 can provide a control for a recurrence of the challenge. This control can include a link back to the game (e.g., based on the game ID as discussed above) allowing either or both players to repeat their attempt at the game, either as a new comparison of milestone values or for the player with the lower milestone value to take another attempt at besting the milestone value of the winning player. Process 2200 can be repeated as the conversation thread continues and can end when the conversation thread is closed, or the players choose not to repeat the challenge.

A shared space coordinator can establish a shared space for a 3D call in which participants of the 3D call both see content that is not reversed while seeing consistent spatial representations of each other's movements in relation to content in the shared space. The shared space coordinator can accomplish this by presenting the holographic representation of each participant as mirrored (as compared to the images of that participant captured by a capture device) when the participants are on opposite sides of the shared space. Thus, while each participant will see the content, such as a shared whiteboard, from the same perspective (i.e., any words on the shared whiteboard will appear from the correct orientation to each participant) an action by either participant in relation to the content will be viewed consistent spatially by each participant. As a more specific example, the whiteboard may have the word “cat” on the left side and “dog” on the right side. While each participant sees these words from the front with these positions, when a first call participant points at the word “cat” from their perspective, because the hologram of the first participant is mirrored for a second call participant, the second call participant sees the first participant as pointing at the word “cat,” despite the versions of the whiteboard being presented according to each participants frontward position. Without this mirroring, the second participant would see the first participant pointing at “dog” when the first participant is actually pointing at “cat.” Additional details on setting up holographic calling and generating holographic representations of participants are described in U.S. patent application Ser. No. 17/360,693, titled Holographic Calling for Artificial Reality, filed on Jun. 28, 2021, which is herein incorporated by reference in its entirety.

Further, the shared space coordinator can initialize and size the shared space dynamically according to the amount of content in the shared space and/or according to a user-specified size for the shared space. For example, when a participant enables a whiteboard, the whiteboard can be initially a default size, and can be expanded as the participants add content. The shared space can be automatically enlarged to fit the whiteboard as it expands. As another example, the shared space can initially be a size set by a participant, but as additional 3D models are added to the shared space, the shared space can be enlarged to fit the added models. In some cases, as the shared space size is changed, the position and/or size of the holographic representation of the other call participant can be adjusted to keep them just on the other side of the shared space.

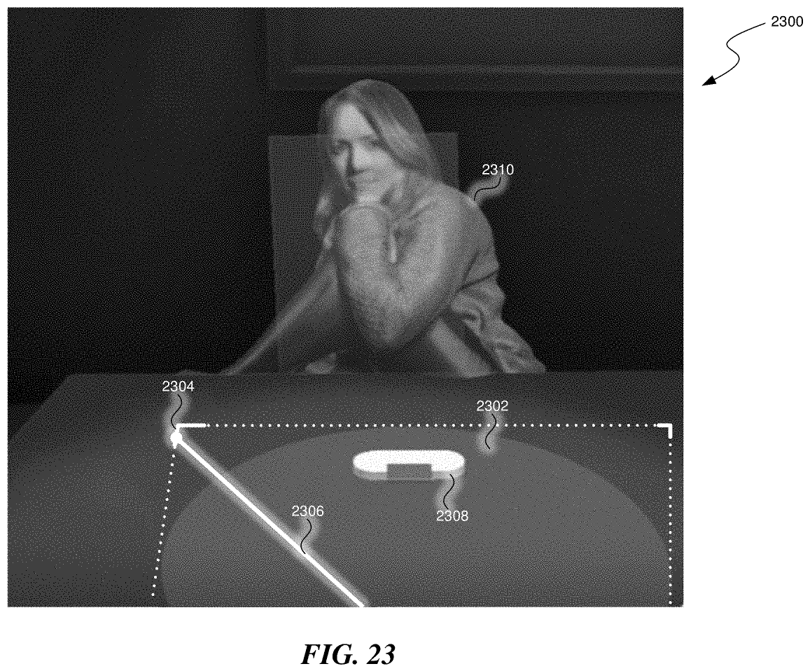

FIG. 23 is an example 2300 of a participant specifying a size for a shared space for a 3D call. In example 2300, a shared space 2302 has been established for a call between a first participant (not shown - who is being captured by a capture device 2308), and a second participant, whose holographic representation 2310 is shown on the opposite side of the shared space 2302 from the first participant. The shared space 2302 has a size outlined with a dotted line with sizing controls 2304. The first participant can adjust the size of the shared space 2302 by repositioning the sizing controls 2304, e.g., by pointing ray 2306 at the sizing controls 104 and dragging them to another location.

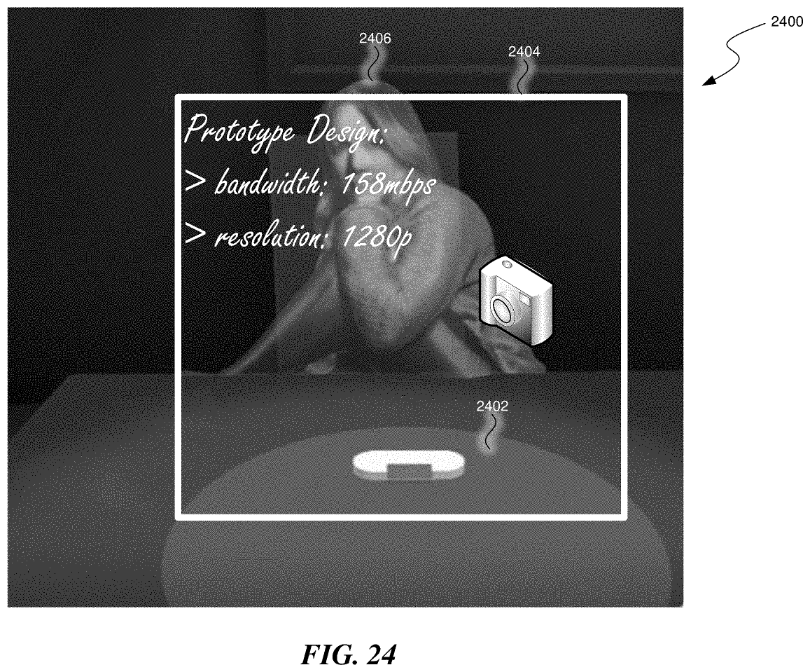

FIG. 24 is an example 2400 of an initialized 3D call with a shared space containing a whiteboard. In example 2400, shared space 2402 has been established with a virtual whiteboard 2404 containing text and an image of a camera. Each participant in the call sees the virtual whiteboard 2404 from the front (i.e., so the words are viewable on the upper left corner, readable from left to right). However, the hologram 2406 of the second call participant is mirrored, allowing the second call participant to point at areas of the whiteboard 2404 while the first participant sees the second call participant pointing at the area of the whiteboard 2404 intended by the second call participant.

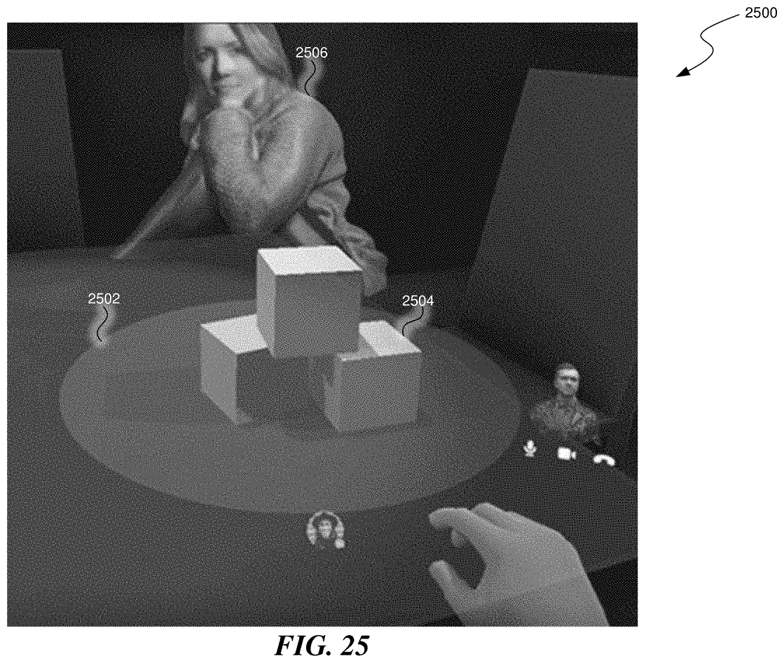

FIG. 25 is an example 2500 of an initialized 3D call with a shared space containing a volume with shared 3D models. In example 2500, shared space 2502 has been established and the call participants have added virtual objects such as block 2504 to the shared space. Each participant in the call sees the virtual objects from the same perspective. However, the hologram 2506 of the second call participant is mirrored, allowing the second call participant to interact with the virtual objects while the first participant sees the second call participant using the virtual objects in the same manner as the second call participant.

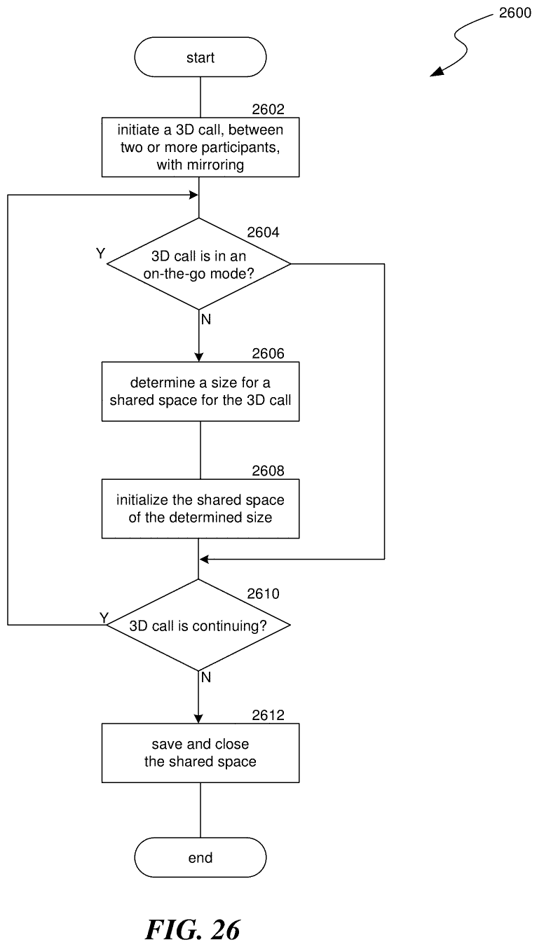

FIG. 26 is a flow diagram illustrating a process 2600 used in some implementations for establishing a 3D call with a shared space. In some implementations, process 2600 can be performed by an artificial reality device in response to the beginning of a 3D call.

At block 2602, process 2600 can initiate a 3D call between two participants with participant holograms mirrored. In some cases, process 2600 is performed only for 3D calls between two participants, while in other cases process 2600 can be performed for more than two participants (which can include presenting other participants as overlapping). When the call participants are facing each other in the 3D call, process 2600 can transform their holographic representations to be mirrored (i.e., flipped horizontally), such that their interactions in relation to shared content are consistent between the views of a first participant and the second participant. This allows participant's spatial movements to appear correct when viewed by the other participant, while each participant sees the shared content from the correct perspective. Thus, process 2600 can mirror either or both A) shared content (e.g., a whiteboard or 3D volume between 3D call participants) and B) the hologram of the other call participant, so as to avoid either participant seeing the shared content as backward while preserving the spatial relationships between a participant's actions in the shared content.

At block 2604, process 2600 can determine whether the 3D call is in an on-the-go mode. On-the-go mode can be enabled when process 2600 determines that the call participant is walking or driving (which can be determined based on monitored movements of a capture device capturing images of the call participant), when the capture device is disabled, or though an explicit on-the-go mode selection by a participant. When the 3D call in is in the on-the-go mode, process 2600 can close a shared space if opened in a previous iteration of process 2600 at block 2608, and can go to block 2610.

At block 2606, process 2600 can determine a size for a shared space for the 3D call. In various implementations, the size can be set according to a default size, through a participant's manual size selection, automatically based on amount of content in the shared space, and/or automatically according to a size of flat surface in front of each participant.

At block 2608, process 2600 can initialize the shared space of the determined size. If the shared space has already been initialized in a previous iteration of process 2600, the shared space can be resized according to the size determined at block 2606. The shared space is an area where participants can view and interact with shared 3D content, such as 3D models, a shared whiteboard, etc. In some cases, the shared content used by process 2600 is only 2D content (such as that presented on a whiteboard). In some implementations, the shared space can be pre-populated, such as with content saved from a shared space of a previous call between the same participants (see block 2612), with a transparent or semi-transparent whiteboard, with content items either participant has saved to a thread for the participants, etc. In some cases, the dimensions of the shared space can define where the virtual representations of the participants are placed and/or can suggest a best position of the capture device for the participants.

At block 2610, process 2600 can determine whether the 3D call is continuing. This determination can be based on commands from either participant ending the 3D call. If the 3D call is continuing, process 2600 can return to block 2604. If the 3D call is ending, process 2600 can continue to block 2612.

At block 2612, process 2600 can save the shared space content and close the shared space. In some cases, the shared space can persist after the call ends, allowing either participant to continue viewing the shared content. In some cases, changes to such a persisting shared space by a first participant can be reflected in a version of the shared space of the second call participant. In other cases, once the call ends, the link between the versions of the shared spaces also ends, causing further changes to only be reflected locally. In some cases, process 2600 can also save the content items and their positions in the shared space, allowing the participant to recall them to view a history of the call and/or to continue with the same shared space content and configuration when another call between the same participants is begun (and a shared space is initialized in a next execution of block 2608). In some cases, the saved space can be also be recalled in live interactions between the same participants. For example, an artificial reality device can determine which users are around (or that the artificial reality device user is interacting with), index this user set to a list of saved shared spaces, and can present one that matches the set of users (or in some cases a subset of these users).

A spatial messaging system can provide a setup flow for a recipient user to establish a physical space (also referred to herein as a 3D space or a real-world space) as a messaging inbox. The spatial messaging system can provide a representation of this physical space to a sending user, which the sending user can select as a destination for a 3D message. The sending user can also select a particular delivery point within the physical space at which the 3D message will be pinned upon delivery. When the recipient user is near the physical space designated as the messaging inbox to which a 3D message has been sent, the spatial messaging system can display the message at the delivery point.

To establish the messaging inbox, the spatial messaging system can take a scan of the physical space. For example, an artificial reality device or mobile phone can have one or more depth sensors which can determine a mesh of the scanned space. As another example, a non-depth-enabled phone may take multiple flat images from different perspectives to generate depth data and/or one or more flat images may be provided to a machine learning model trained to estimate depth data for the flat image(s). Based on the captured or generated depth data, the spatial messaging system can generate a model of the physical space as a messaging inbox. A user may be able to designate particular spaces within the captured depth or flat images that should be setup as the messaging inbox. The spatial messaging system may automatically identify surfaces, particular objects, or types of objects within the scanned physical space that the spatial messaging system can set as pre-defined anchor points to which messages can be sent.

The representation of the scanned physical space can be provided to a sending user in a variety of formats. For example, if the device of the sending user only has a flat screen, the representation may be provided as a 2D image, whereas if the device of the sending user is capable of presenting virtual 3D objects in an artificial reality environment, the representation may be provided as a 3D mesh. In various implementations, the sending user may be able to select any given point in the representation as a delivery point or may be able to select one of a set of pre-defined anchor points, e.g., defined based on automatically identified surfaces, objects, or object types in the physical space.

When the 3D message is delivered to the spatial messaging system of the recipient, spatial messaging system of the recipient can determine when the recipient user is within a threshold distance of the physical space, and when this occurs, can provide a representation of the 3D message in the physical space. In some cases, this can initially be a minimized version of the 3D message (e.g., an icon representation) which the recipient user can select to open the full message. In some cases, the 3D message will only stay in the messaging inbox for a set amount of time, after which it disappears unless the recipient user has pinned it to stay in the messaging inbox or pinned it to another location outside the messaging inbox.

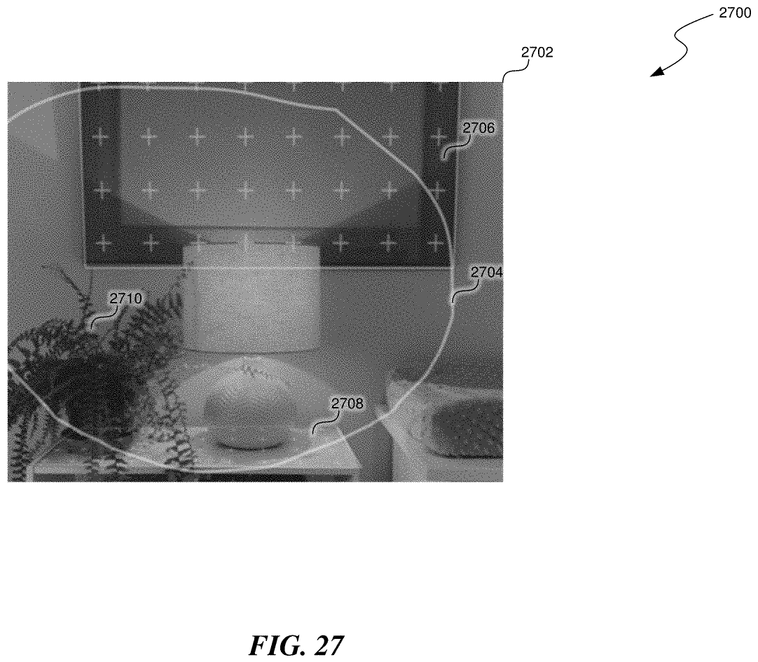

FIG. 27 is an example 2700 of scanning a real-world space as a messaging inbox. In example 2700, a user has directed a depth sensing artificial reality device at a real-world space 2702, which has automatically identified surfaces 2706 and 2708 and object 2710 as potential anchor points for receiving messages. Through the artificial reality device tracking hand positions of the user, the user has traced area 2704 which she is designating as the messaging inbox, with the automatically identified surfaces and objects within this area being the eligible delivery points.

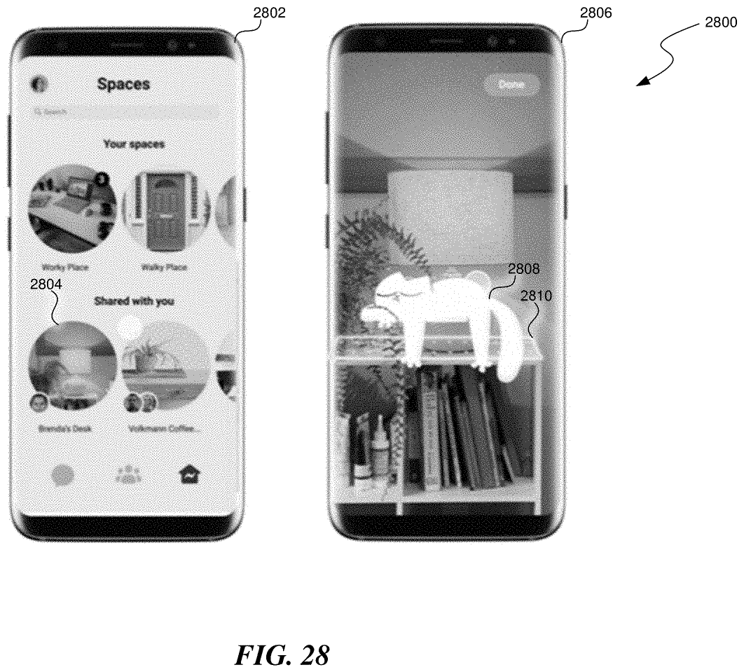

FIG. 28 is an example 2800 of selecting a delivery point, in a scanned real-world space, for a 3D message. Example 2800 illustrates two views 2802 and 2806 through a sending user's mobile phone. In view 2802, the sending user is selecting a messaging inbox 2804 (the messaging inbox setup in example 2700) from among a set of messaging inboxes that potential recipient users have shared with the sending user. In view 2806, the sending user has selected a message 2808 and is placing the message 2808 in the physical area of the messaging inbox 2804. As the sending user drags the message 2808 around the displayed representation of the physical space, the various pre-defined anchor points are highlighted. In view 2806, the sending user is selecting the surface of pre-defined anchor point 2810 as the delivery point for the message 2808.

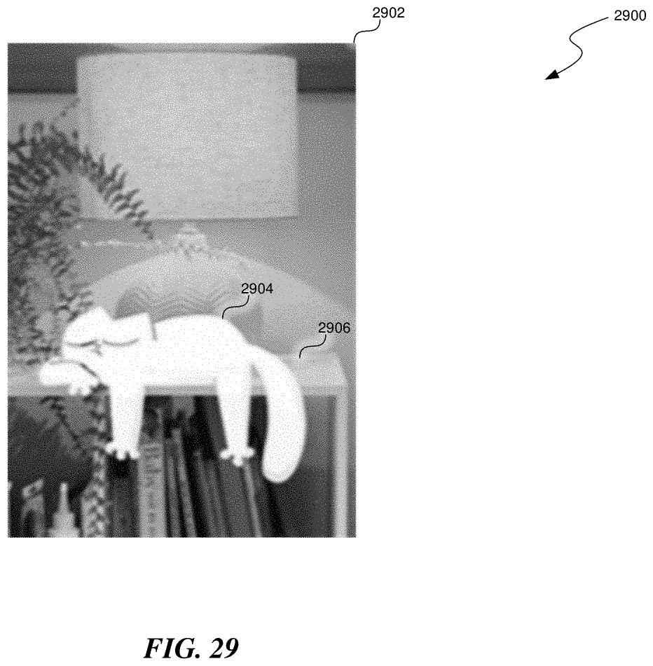

FIG. 29 is an example 2900 of receiving a 3D message at a delivery point in a scanned real-world space. Example 2900 illustrates the physical space 2902 of the messaging inbox (setup in example 2700) having received a 3D message 2904 (sent in example 2800). In example 2900, the artificial reality device has determined that the recipient user is within a threshold distance of the messaging inbox, and thus has displayed the message 2904, on the delivery point 2906 (the pre-defined anchor point selected by the sending user).

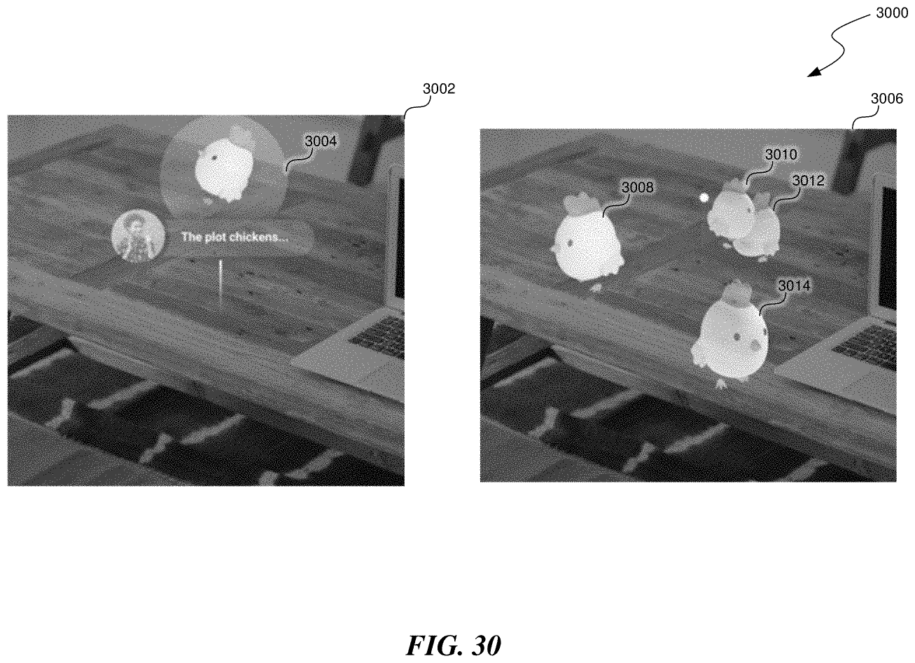

FIG. 30 is an example 3000 of receiving a 3D message as an expandable glint at a delivery point in a scanned real-world space. Example 3000 illustrates two views 3002 and 3006 of a recipient user's view of the scanned real-world space, previously scanned as a messaging inbox. In view 3002, a message has been received and the recipient user is within a threshold distance of the messaging inbox. In response, an artificial reality device has displayed a minimized view 3004 of the received message, including an icon for the 3D content of the message, an icon of the sending user, and a preview of text of the message. In view 3006, the user has selected the minimized view 3004, causing it to be maximized, which in example 3000 includes displaying 3D objects 3008-3014.

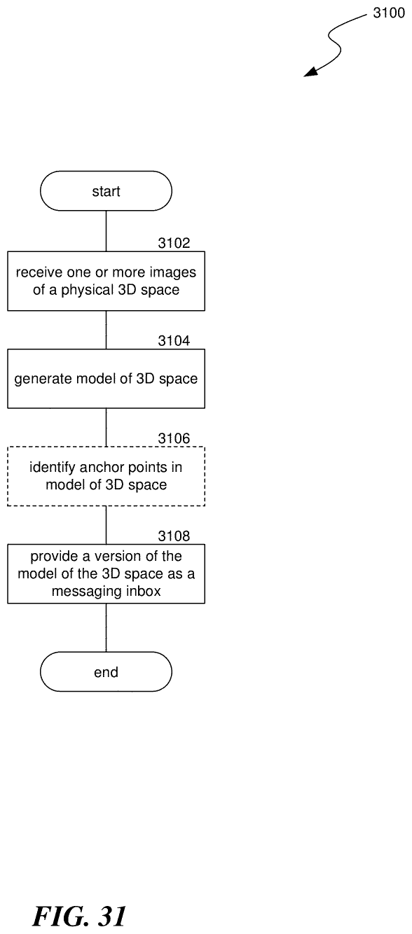

FIG. 31 is a flow diagram illustrating a process 3100 used in some implementations for scanning a physical space to onboard it as a messaging inbox. In some cases, process 3100 can be performed on a client such as an artificial reality device, a mobile device (e.g., smartphone), or other device capable of obtaining sensor data for a physical space. In other cases, process 3100 can be performed by a server system receiving data from such a client device.

At block 3102, process 3100 can receive one or more images of a physical 3D space. In various cases, the images can be depth images and/or traditional 2D images. The images can be captured by, e.g., an artificial reality device, a depth-enabled phone, a traditional camera (e.g., in a phone) where multiple of these 2D images with offsets from each other can be used to determine depth information or a one or more such traditional images can be provided to a machine learning model trained to estimate depth data.

At block 3104, process 3100 can generate a model of the 3D space based on the images received at block 3102. In some implementations, the model can be for the entire area depicted (e.g., the field-of-view) or for a sub-area selected by the user (e.g., by performing a selection gestures such as outlining the sub-area with her hand or by selecting an area automatically identified by process 3100).

While any block can be removed or rearranged in various implementations, block 3106 is shown in dashed lines to indicate there are specific instances where block 3106 is skipped. At block 3106, process 3100 can identify anchor points in model of 3D space. For example, process 3100 can identify flat surfaces that are above a threshold size, open volumes above a threshold size, and/or particular objects or type of objects that can be set as delivery points for 3D messages. In some cases, surfaces can be assigned a layout template (user selected or automatically selected based on a mapping of surface characteristics to templates) specifying how objects placed on the surface will be arranged.

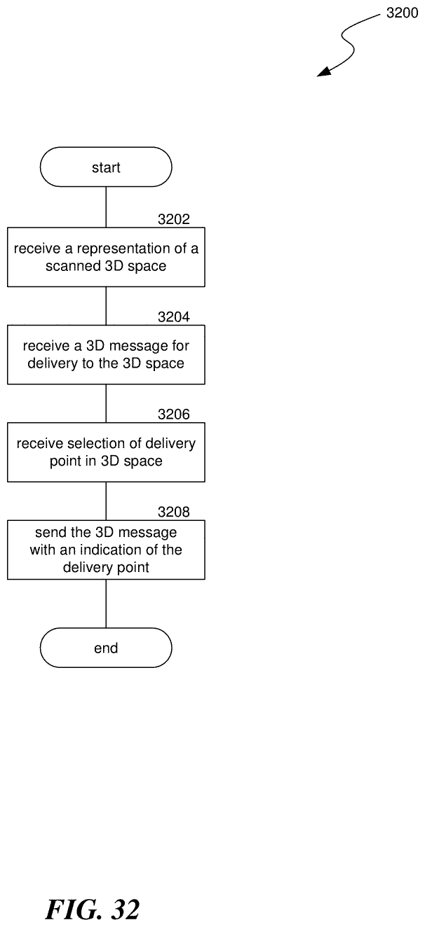

At block 3108, process 3100 can provide a version of the model of the 3D space as a messaging inbox. In some cases, the version of the model can be a mesh, allowing a recipient device to display the mesh as a 3D object to a sending user. In other cases, the version of the model can be a flat image, allowing a recipient device to display flat image for a sending user to tap on to select destination points (as discussed below in relation to FIG. 32). In some cases, the type of the version of the model that is used is based on the type of the device used by the sending user. For example, where the sending user is using an artificial reality device, the version can be a mesh, whereas when the sending user is using a smartphone, the version can be a flat image. In some cases, the mesh version can have reduced details (e.g., exchanging model details for more general shapes) allowing the mesh to be quickly transferred over low bandwidth connections and preserving privacy of the recipient user.

In some cases, the recipient user can select particular sending users, sets of sending users (e.g., those designated as her “friends” on a social media site), or other user groupings who are eligible to see the version of the model. Once the version of the model is provided, process 3100 can end.

FIG. 32 is a flow diagram illustrating a process 3200 used in some implementations for providing a scanned 3D space for a message sender to select a delivery point. In some cases, process 3200 can be performed on a client such as an artificial reality device, mobile device (e.g., smartphone), or other device capable of displaying a representation of a physical space. In other cases, process 3200 can be performed by a server system coordinating data with such a client device.

At block 3202, process 3200 can receive a representation of a scanned 3D space. This can be the version provided by block 3108 of FIG. 31, i.e., it can be a mesh or a flat image showing the physical space. In some implementations, the sending user can first select a recipient and/or a space scanned by the recipient and made available to the sending user (e.g., from a list of spaces associated with a designated recipient user). In some implementations, the type of the representation received can depend on the type of device performing process 3200. For example, if the device is an artificial reality device, process 3200 can receive a mesh as the representation, whereas if the device has a flat screen display, process 3200 can receive a flat image as the representation.

At block 3204, process 3200 can receive a 3D message for delivery to the 3D space. In various implementations, the 3D message can include one or more of a 3D model, text, an image, an animation, a drawing on the representation of the 3D space, etc. In some cases, the providing of the 3D message, such as a drawing on the representation, can indicate a position in the 3D space which will be the delivery point, in which case the following block 3206 may be skipped.

At block 3206, process 3200 can receive selection of a delivery point in the 3D space. In some implementations, the delivery point can be any particular point in the 3D space indicated by the sending user. In other implementations, the delivery point can be selected by the sending user from a set of pre-defined anchor points (e.g., defined at block 3106 of FIG. 31). For example, the sending user may be able to drag her message across her screen, which can highlight various surfaces or points pre-defined as anchor points. In some implementations, process 3200 may only highlight anchor points that are eligible for receiving the message (e.g., based on size, mapping of content types / formats to anchor types, etc.) In other cases, process 3200 may format the message for the selected anchor point, e.g., configuring it to be placed on a horizontal or vertical surface if selected as the delivery point, resizing the message to fit on the confines of a selected surface or in a selected volume, etc.

At block 3208, process 3200 can send the 3D message received at block 3204 with an indication of the delivery point selected at block 3206. Sending the 3D message can cause the recipient system to display the 3D message in the 3D space at the delivery point. In some implementations, the recipient user may only receive the 3D message when she is within a threshold distance of the 3D space. In some case, the recipient user may not be otherwise notified of the message before she is within the threshold distance of the 3D space. In some cases, delivery of the message can include first showing the message as a glint (i.e., an icon or otherwise minimized version of the message), which the recipient user can select to expand into the full message. In some cases, the message may disappear upon certain triggers such as a timer expiring, the recipient's attention being off the message for a threshold time, the recipient user moving the threshold distance away from the 3D space, etc., unless the recipient user has pinned the message not to disappear or has saved it to another location. Following sending the 3D message, process 3200 can end.

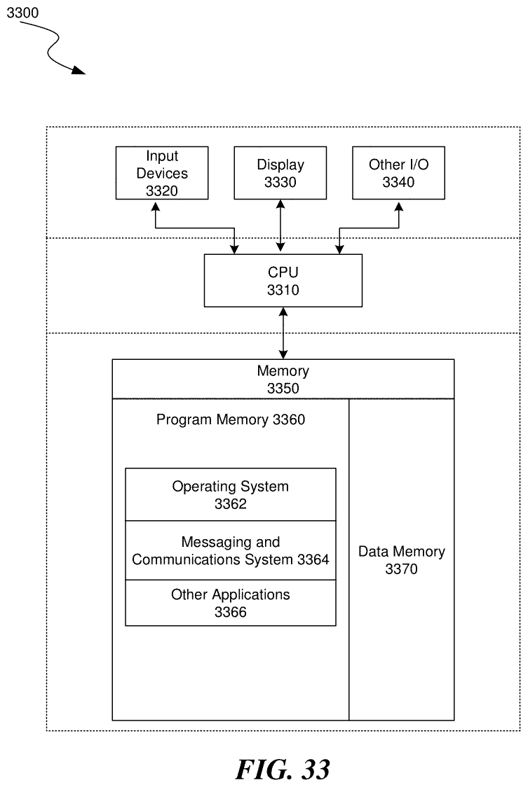

FIG. 33 is a block diagram illustrating an overview of devices on which some implementations of the disclosed technology can operate. The devices can comprise hardware components of a device 3300 that can facilitate various communication, which may be connected to artificial reality systems. Device 3300 can include one or more input devices 3320 that provide input to the Processor(s) 3310 (e.g., CPU(s), GPU(s), HPU(s), etc.), notifying it of actions. The actions can be mediated by a hardware controller that interprets the signals received from the input device and communicates the information to the processors 3310 using a communication protocol. Input devices 3320 include, for example, a mouse, a keyboard, a touchscreen, an infrared sensor, a touchpad, a wearable input device, a camera- or image-based input device, a microphone, or other user input devices.

Processors 3310 can be a single processing unit or multiple processing units in a device or distributed across multiple devices. Processors 3310 can be coupled to other hardware devices, for example, with the use of a bus, such as a PCI bus or SCSI bus. The processors 3310 can communicate with a hardware controller for devices, such as for a display 3330. Display 3330 can be used to display text and graphics. In some implementations, display 3330 provides graphical and textual visual feedback to a user. In some implementations, display 3330 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 3340 can also be coupled to the processor, such as a network card, video card, audio card, USB, firewire or other external device, camera, printer, speakers, CD-ROM drive, DVD drive, disk drive, or Blu-Ray device.

In some implementations, the device 3300 also includes a communication device capable of communicating wirelessly or wire-based with a network node. The communication device can communicate with another device or a server through a network using, for example, TCP/IP protocols. Device 3300 can utilize the communication device to distribute operations across multiple network devices.

The processors 3310 can have access to a memory 3350 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 3350 can include program memory 3360 that stores programs and software, such as an operating system 3362, messaging and communications System 3364, and other application programs 3366. Memory 3350 can also include data memory 3370, e.g., configuration data, settings, user options or preferences, etc., which can be provided to the program memory 3360 or any element of the device 3300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

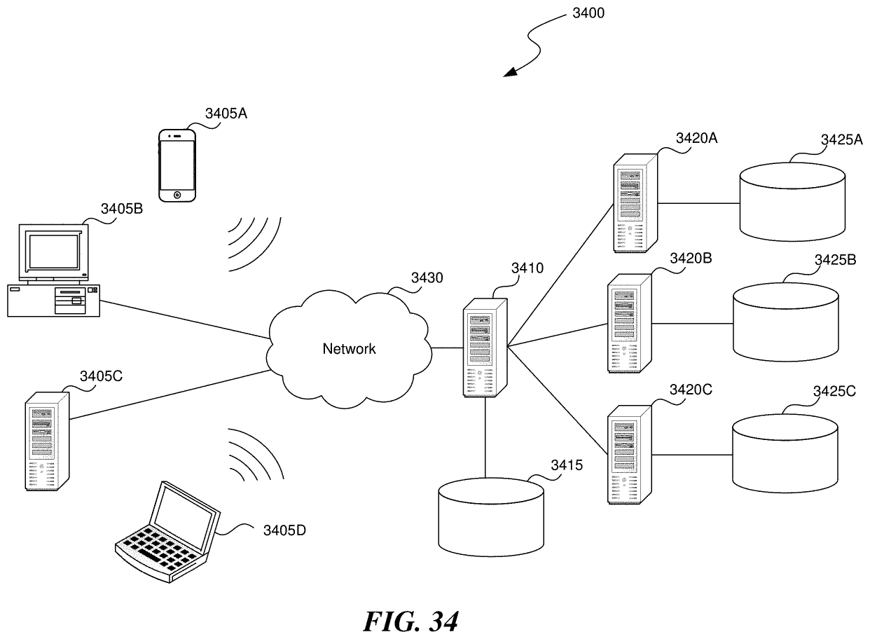

FIG. 34 is a block diagram illustrating an overview of an environment 3400 in which some implementations of the disclosed technology can operate. Environment 3400 can include one or more client computing devices 3405A-D, examples of which can include device 3300. Client computing devices 3405 can operate in a networked environment using logical connections through network 3430 to one or more remote computers, such as a server computing device.

In some implementations, server 3410 can be an edge server which receives client requests and coordinates fulfillment of those requests through other servers, such as servers 3420A-C. Server computing devices 3410 and 3420 can comprise computing systems, such as device 3300. Though each server computing device 3410 and 3420 is displayed logically as a single server, server computing devices can each be a distributed computing environment encompassing multiple computing devices located at the same or at geographically disparate physical locations. In some implementations, each server 3420 corresponds to a group of servers.

Client computing devices 3405 and server computing devices 3410 and 3420 can each act as a server or client to other server/client devices. Server 3410 can connect to a database 3415. Servers 3420A-C can each connect to a corresponding database 3425A-C. As discussed above, each server 3420 can correspond to a group of servers, and each of these servers can share a database or can have their own database. Databases 3415 and 3425 can warehouse (e.g., store) information. Though databases 3415 and 3425 are displayed logically as single units, databases 3415 and 3425 can each be a distributed computing environment encompassing multiple computing devices, can be located within their corresponding server, or can be located at the same or at geographically disparate physical locations.

Network 3430 can be a local area network (LAN) or a wide area network (WAN), but can also be other wired or wireless networks. Network 3430 may be the Internet or some other public or private network. Client computing devices 3405 can be connected to network 3430 through a network interface, such as by wired or wireless communication. While the connections between server 3410 and servers 3420 are shown as separate connections, these connections can be any kind of local, wide area, wired, or wireless network, including network 3430 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following:

A method for adding a like to a gesture target, the method comprising: recognizing a like gesture; identifying a gesture target for the like gesture; and in response to the like gesture, adding a like to the gesture target.

A method for administering a conversation thread, for a game, over a messaging platform, the method comprising: identifying a transition trigger for the game; capturing a status related to the transition trigger; matching the captured status with a conversation thread; configuring the captured status for output to the conversation thread; and causing the configured captured status to be output to the conversation thread.

A method for connecting a game with a conversation thread to coordinate a game challenge, the method comprising: obtaining a game milestone value associated with a first player's accomplishment of a game milestone; identifying one or more challenge recipients; formatting a game challenge message, for a conversation thread including the one or more challenge recipients, based on the game milestone value; and causing the game challenge message to be provided to the one or more challenge recipients in the conversation thread.

A method for establishing a 3D call with a shared space, the method comprising: initiating a 3D call, between two participants, with mirroring, wherein the mirroring causes a holographic representation of a second participant to be mirrored from their captured representation such that their interactions in relation to shared content are consistent between a views of a first participant and a view of the second participant; determining a size for a shared space for the 3D call; initializing the shared space of the determined size; and determining an end to the 3D call and, in response, saving and closing the shared space.

A method for establishing and administering a physical space as a messaging inbox, the method comprising: generating a model of the physical space using depth data that is based on sensor data from an imaging device; providing a representation of the model to a device of a sending user, wherein the device of a sending user: provides the representation of the model as output; receives a 3D message; and receives, in relation to the outputted representation of the model, a delivery point in the physical space; receiving the 3D message and an indication of the delivery point from the device of the sending user; and providing an indication of the 3D message, appearing in relation to the physical space at the delivery point.

I/we claim:

1. A method for providing avatar reactions to message sentiments, the method comprising:
receiving a message to be provided via an avatar;
identifying a sentiment matching content of the message;
mapping the identified sentiment to an avatar reaction; and
causing the avatar to perform the avatar reaction.

2. A computer-readable storage medium storing instructions that, when executed by a computing system, cause the computing system to perform a process comprising:
receiving information specifying real-world physical locations of multiple users who are each represented by an avatar in an artificial reality environment;
identifying at least two of the real-world physical locations as matching each other; and
in response to the identifying, causing the avatars, representing the users whose real-world physical locations match, to be grouped, wherein the location of the group of avatars is not based on real-world positions of the represented users.

3. A method for triggering, from an artificial reality (XR) device, an action on a personal computing device, the method comprising:
identifying, on the XR device, a trigger mapped to personal computing device action;
connecting to an action service running on the personal computing device; and
providing a command to the action service to perform the personal computing device action mapped to the identified trigger.
